(19) United States
(12) Patent Application Publication
(10) Pub. No.: US 2007/0184212 A1
(43) Pub. Date: Aug. 9, 2007

(54) Polarizer-protective film, and polarizer and liquid-crystal display device comprising the film

(75) Inventors: Shigeaki Nimura, Minami-Ashigara-shi (JP); Takashi Kobayashi, Fujinomiya-shi (JP); Hidetoshi Watanabe, Minami-Ashigara-shi (JP); Jun Watanabe, Minami-Ashigara-shi (JP); Takato Suzuki, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/698,147

(22) Filed: Jan. 26, 2007

(30) Foreign Application Priority Data
Jan. 27, 2006 (JP) P2006-019376
May 23, 2006 (JP) P2006-143124
Oct. 20, 2006 (JP) P2006-286545

(51) Int. Cl. C09K 19/00

(52) U.S. Cl. 428/1.31

(57) ABSTRACT

A polarizer-protective film includes: a film including a polyester resin as the essential ingredient thereof, and having a moisture permeability of at most 700 g/m²·day and an in-plane retardation Re of at least 500 nm; and a light-scattering layer provided on at least one surface of the film.

### BACKGROUND OF THE INVENTION

1. Field of the Invention

The present invention relates to a polarizer-protective film, and to a polarizer and a liquid-crystal display device comprising the film.

2. Background Art

With remarkable development of information industry, display devices have become much used in various places. In particular, the development of liquid-crystal display devices is noticeable, and the devices have become mounted in various appliances.

In such liquid-crystal display devices, the display quality stability in installation environments is an important matter. Relative to the display quality stability, the polarizer used in liquid-crystal display devices is required to have good stability and the durability.

A polarizer generally comprises a polarizing element sandwiched between two protective films, in which the polarizer-protective film is preferably triacetyl cellulose (TAC).

However, since moisture may permeate through TAC in some degree, light leakage through it may occur when the polarizer is left in a high-humidity or low-humidity state for a long period of time, and therefore the device comprising it could not hold good display quality and in particular, this may be often problematic in TN-mode display devices.

The recent tendency in the art is toward thin polarizers. When a protective film of a triacetyl cellulose film (TAC film) is thinned for producing a thin polarizer, there may occur some problems in that the moisture permeation resistance and the dimensional stability of the thin film may worsen. In particular, a thin film having a thickness of less than 40 μm is problematic in that its physical properties significantly worsen and it could hardly impart sufficient durability to polarizers.

For the purpose of improving the durability of polarizers, disclosed is use of a stretched polymer film, for example, a protective film comprising a polyester resin as the essential ingredient thereof (JP-A-2000-356714 (the term “JP-A” as used herein means an “unexamined published Japanese patent application”), JP-A-2002-008223, JP-A-2002-116320, JP-A-2004-205773 and JP-A-2004-219620).

These methods could improve the durability of polarizers as compared with the case of using TAC, but are problematic in that the films may have rainbow-like unevenness and the visibility through them is poor.

### SUMMARY OF THE INVENTION

An object of the invention is to provide a polarizer-protective film which is free from a problem of light leakage at high humidity or low humidity and from a problem of rainbow-like unevenness when used in liquid-crystal display devices, and to provide a polarizer and a liquid-crystal display device comprising the film.

We, the present inventors have clarified that the expression mechanism of the above-mentioned rainbow-like unevenness may be explained because of the stretched film that expresses large birefringence therefore causing birefringent interference, and have found that, when a light-scattering layer is provided on the surface of the polyester film, then it prevents the rainbow-like unevenness, and have therefore completed the present invention.

The invention includes the following:

(1) A polarizer-protective film comprising: a film including a polyester resin as the essential ingredient thereof, and having a moisture permeability of at most 700 g/m²·day and an in-plane retardation Re of at least 500 nm; and a light-scattering layer provided on at least one surface of the film.

(2) The polarizer-protective film as described in the item (1), which has a total haze of from 10 to 80%.

(3) The polarizer-protective film as described in the item (1), which has a surface haze of from 0.3 to 70%.

(4) The polarizer-protective film as described in the item (1), which has an internal haze of from 10 to 80%.

(5) The polarizer-protective film as described in the item (1), wherein the film has a transmittance at 380 nm of from 0 to 50%, and has a transmittance at 600 nm of from 80 to 100%.

(6) The polarizer-protective film as described in the item (1), wherein the film contains a UV absorbent.

(7) The polarizer-protective film as described in the item (6), wherein, when it is heated up to a temperature of 300° C. at a heating speed of 10° C./min in nitrogen gas, the UV absorbent has mass loss of 10% or less.

(8) The polarizer-protective film as described in the item (6), wherein the UV absorbent is at least one UV absorbent represented by formula (1): 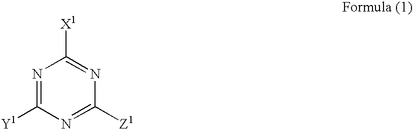
wherein X¹, Y¹ and Z¹ each independently represent a substituted or unsubstituted alkyl, aryl, alkoxy, aryloxy, alkylthio, arylthio or heterocyclic group; and at least one of X¹, Y¹ and Z¹ is a substituent represented by formula (A): 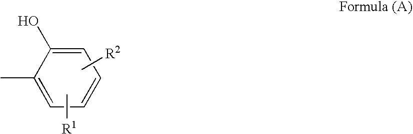
wherein R¹ and R² each independently represent a hydrogen atom, a halogen atom, a substituted or unsubstituted alkyl, alkenyl, aryl, alkoxy, aryloxy, acyloxy, alkylthio, arylthio, amino, acyl, oxycarbonyl, carbamoyl or sulfamoyl group, or a carboxyl group or a salt thereof, or a sulfo group or a salt thereof, and the adjacent R¹ and R² may bond to each other to form a ring.
(9) The polarizer-protective film as described in the item (1), wherein the water content of the film is at most 1%.
(10) The polarizer-protective film as described in the item (1), wherein the modulus of elasticity of the film is from 3 to 7 GPa.
(11) The polarizer-protective film as described in the item (1), wherein the thickness of the film is from 5 to 200 μm.
(12) The polarizer-protective film as described in the item (1), wherein the glass transition temperature of the polyester resin is 80° C. or higher.
(13) The polarizer-protective film as described in the item (1), wherein the polyester resin has a group selected from the group consisting of a sulfonic acid and a salt thereof.
(14) The polarizer-protective film as described in the item (1), wherein at least one surface of the film is subjected to corona discharge treatment.
(15) The polarizer-protective film as described in the item (1), wherein at least one surface of the film is subjected to glow discharge treatment.
(16) The polarizer-protective film as described in the item (1), wherein an adhesive layer is provided on at least one surface of the film.
(17) The polarizer-protective film as described in the item (16), wherein the adhesive layer contains at least one selected from the group consisting of an acrylate-based latex, a methacrylic acid-based latex and a styrene-based latex.
(18) The polarizer-protective film as described in the item (16), wherein the adhesive layer contains a UV absorbent.
(19) The polarizer-protective film as described in the item (16), wherein the adhesive layer contains a conductive metal oxide.
(20) The polarizer-protective film as described in the item (16), wherein the adhesive layer has a thickness of from 50 to 1000 nm.
(21) The polarizer-protective film as described in the item (16), wherein a hydrophilic polymer-containing layer is further provided on the adhesive layer.
(22) The polarizer-protective film as described in the item (21), wherein the hydrophilic polymer-containing layer contains a UV absorbent.
(23) The polarizer-protective film as described in the item (21), wherein the hydrophilic polymer-containing layer has a thickness of from 50 to 1000 nm.
(24) The polarizer-protective film as described in the item (1), wherein, in the production of the film, the film is stretched by from 1.5 times to 7 times in the film-traveling direction and by from 1.5 times to 7 times in the direction vertical to the traveling direction.
(25) A polarizer comprising: a polarizing element; and a polarizer-protective film as claimed in claim 1 which is arranged at one side of the polarizing element.
(26) The polarizer as described in the item (25), wherein the polarizer-protective film comprises a cellulose ester film as the essential ingredient thereof.
(27) The polarizer as described in the item (25), wherein the polarizer-protective film has a viewing angle compensatory function.
(28) The polarizer as described in the item (25), wherein the polarizer-protective film is coated with an optically-anisotropic layer.
(29) A liquid-crystal display device comprising: polarizers as described in the item (25) which are arranged at positions facing each other; and a liquid-crystal cell interposed between the polarizers.
(30) The liquid-crystal display device as described in the item (29), wherein the polarizer as described in the item (25) is disposed only on the viewing side of the liquid-crystal cell.
(31) The liquid-crystal display device as described in the item (29), further comprising a brightness-improving film mounted thereon.
(32) The liquid-crystal display device as described in the item (31), wherein the brightness-improving film and the polarizer-protective film adjacent thereto are airtightly adhered to each other.
(33) The liquid-crystal display device as described in the item (29), which adapts a Twisted Nematic mode as a display mode.

The polarizer-protective film of the invention is formed by providing a light-scattering film on a polyester film having a low moisture permeability and a high Re, and the liquid-crystal display device of the invention comprises a polarizer that comprises the polarizer-protective film of the invention, and the device is therefore free from a problem of light leakage at high humidity or low humidity and from a problem of rainbow-like unevenness.

### DETAILED DESCRIPTION OF THE INVENTION

(Polyester Resin and Film Formed with it)

(Polyester)

The polyester resin for use in the invention is not specifically defined in point of its structure. Above all, especially preferred for use herein is a resin obtained through polycondensation of an aromatic dicarboxylic acid and an aliphatic glycol.

Concretely, for example, it includes polyethylene terephthalate, polybutylene terephthalate, polybutylene naphthalate. Above all, especially preferred is polyethylene terephthalate from the viewpoint of the cost and the mechanical strength of the resin.

The aromatic dicarboxylic acid includes terephthalic acid as well as isophthalic acid, 2,6-naphthalenedicarboxylic acid, and also their lower alkyl esters (including anhydrides and derivatives capable of forming esters such as lower alkyl esters).

The aliphatic glycol includes ethylene glycol, propylene glycol, butanediol, neopentyl glycol, 1,4-cyclohexanedimethanol, diethylene glycol, p-xylylene glycol.

Above all, preferred is a resin comprising, as the essential ingredient thereof, polyethylene terephthalate obtained through reaction of terephthalic acid and ethylene glycol.

The resin comprising polyethylene terephthalate as the essential ingredient thereof means a copolymer having repetitive units of polyethylene terephthalate in an amount of at least 80 mol % or a blend polymer containing polyethylene terephthalate in an amount of at least 80% by mass.

The aromatic dicarboxylic acid having a group selected from sulfonic acid and its salt, which is used for making the polyester for use in the invention have a sulfonic acid group introduced thereinto includes 5-sodium-sulfoisophthalic acid, 2-sodium-sulfoisophthalic acid, 4-sodium-sulfoisophthalic acid, 4-sodium-sulfo-2,6-naphthalenedicarboxylic acid, and their ester-forming derivatives, and compounds derived from them by substituting sodium with any other metal (e.g., potassium, lithium).

Also usable herein are glycol derivatives having a group selected from sulfonic acid and its salt introduced thereinto. However, as compounds preferred for introducing a sulfonic acid group into the polyester are the above-mentioned aromatic dicarboxylic acids having a sulfonic acid group or its salt.

When the amount of the aromatic dicarboxylic acid component having a sulfonic acid group or its salt is more than 10 mol % of all the aromatic dicarboxylic acid used in producing the ester, then the ductility of the resulting ester may be poor or the mechanical strength thereof may be low; but when the amount is less than 1 mol %, then the driability of the resulting ester may be poor.

The polyester for use in the invention may be copolymerized with any other component or may be a blend with any other polymer, not detracting from the effect of the invention.

The other aromatic dicarboxylic acids or their derivatives than the above that are usable herein are aromatic dicarboxylic acids such as 2,7-naphthalenedicarboxylic acid, 1,5-naphthalenedicarboxylic acid, diphenyldicarboxylic acid, diphenylether-dicarboxylic acid, and their lower alkyl esters (including anhydrides and derivatives capable of forming esters such as lower alkyl esters). In producing the polyester, additionally usable are alicyclic dicarboxylic acids such as cyclopropane-dicarboxylic acid, cyclobutane-dicarboxylic acid, hexahydroterephthalic acid and their derivatives (including anhydrides and derivatives capable of forming esters such as lower alkyl esters), and aliphatic dicarboxylic acids such as adipic acid, succinic acid, oxalic acid, azelaic acid, sebacic and, dimer acid and their derivatives (including anhydrides and derivatives capable of forming esters such as lower alkyl esters), in an amount of at most 10 mol % of all the dicarboxylic acid.

The glycol usable in the invention includes ethylene glycol and the above-mentioned glycols, and additionally trimethylene glycol, triethylene glycol, tetramethylene glycol, hexamethylene glycol, neopentyl glycol, bisphenol A, p,p′-dihydroxyphenyl sulfone, 1,4-bis(β-hydroxyethoxyphenyl)propane, polyalkylene (e.g., ethylene, propylene) glycol, and p-phenylenebis(dimethylolcyclohexane). Their amount usable herein may be at most 10 mol % of the glycol to be used herein.

The polyester for use in the invention may be blocked at the terminal hydroxyl group and/or carboxyl group with a monofunctional compound such as benzoic acid, benzoylbenzoic acid, benzyloxybenzoic acid or methoxypolyalkylene glycol; or may be modified with an extremely small amount of a trifunctional or tetrafunctional ester-forming compound such as glycerin or pentaerythritol within a range to give a substantially linear copolymer.

The polyester for use in the invention may be copolymerized with a bisphenol compound or a naphthalene ring or cyclohexane ring-having compound for the purpose of improving the heat resistance of the film of the polyester.

Preferably, the polyester for use in the invention has a glass transition temperature (Tg) of not lower than 80° C., more preferably not lower than 90° C. When Tg is lower than 80° C., then the dimensional stability of the resulting film at high temperature and high humidity may be poor. Tg may be obtained from the peak of tanδ in dynamic viscoelasticity measurement.

(Antioxidant)

The polyester for use in the invention may contain an antioxidant. In particular, when the polyester contains a polyoxyalkylene group-having compound, the effect is remarkable. The antioxidant to be added to the polyester is not specifically defined in point of its type, and various types of antioxidants may be used herein. For example, antioxidants of hindered phenol compounds, phosphite compounds or thioether compounds are usable herein. Above all, antioxidants of hindered phenol compounds are preferred in point of the transparency of the polyester film. The amount of the antioxidant to be in the polyester may be generally from 0.01 to 2% by mass of the polyester, more preferably from 0.1 to 0.5% by mass.

If desired, the polyester film of the invention may be lubricated. Not specifically defined, lubrication of the film may be attained in any general method of, for example, an external particle addition method of adding inert inorganic particles to polyester; an internal particle deposition method of depositing the catalyst added in production of polyester; or a method of applying a surfactant onto the film surface.

(UV Absorbent)

If desired, a UV absorbent may be added to the polyester film of the invention for the purpose of preventing degradation of polarizing element and liquid crystal.

From the viewpoint that its UV-absorbing capability is good and it may ensure good liquid-crystal display performance, the UV absorbent is preferably such that the transmittance at a wavelength of 380 nm of the polyester film that contains the UV absorbent is from 0 to 30%, more preferably from 0 to 10%, and that the transmittance at 600 nm thereof is from 80 to 100%, more preferably from 85 to 100%, even more preferably from 90 to 100%.

It is desirable that the polyester for use in the invention is kneaded with at least one UV absorbent of a hardly-volatile UV absorbent of such that, when it is heated up to a temperature of 300° C. at a heating speed of 10° C./min in nitrogen gas, its mass loss % is at most 10%, a heat-resistant UV absorbent of such that the difference between the b value (measured with a color-difference meter) of a polyester resin plate prepared by adding 0.4% by mass of the UV absorbent to a polyester resin, heating it at 300° C. for 1 minute and then shaping it into a plate having a thickness of 1.5 mm, and the b value of a polyester resin plate prepared by heating the UV absorbent-containing polyester resin for 8 minutes and then shaping it into a plate having a thickness of 1.5 mm, is at most 3.0, and a UV absorbent satisfying both the non-volatility and the heat resistance as above.

When a hardly-volatile UV absorbent of such that its mass loss % is at most 10% when heated up to a temperature of 300° C. at a heating speed of 10° C./min in nitrogen gas is used, then the UV absorbent may hardly evaporate away from the film containing it, immediately after the production of the film comprising adding the UV absorbent to a transparent polyester resin followed by melt-kneading it and extruding it out through a die, and therefore the UV-absorbing capability of the UV absorbent is prevented from being lowered or the film does not require a large amount of the UV absorbent. In addition, when a large amount of the UV absorbent evaporates away, then the evaporated (sublimed) UV absorbent may soil the production line and may adhere to the support film that travels through the line. In the invention, these troubles may be evaded. The mass loss is preferably at most 5%, more preferably at most 1%. The UV absorbent having the characteristics as above and usable herein includes those having a structural formula of the following general formula (1), as well as benzophenone-type, benzotriazole-type, salicylate-type, cyanoacrylate-type, benzoxazine-type, and triazine-coumarin copolymer-type UV absorbents, polymer UV absorbents as in JP-A 6-148430, and polymer UV absorbents as in JP-A 2002-31715.

The above-mentioned heat-resistant UV absorbent is stable and does not thermally decompose at the resin temperature (e.g., at 300° C.) during melt-kneading with a polyester resin, and therefore, when it is used in a polyester resin support, it may prevent the support film from being yellowed owing to the decomposition of the UV absorbent and its UV-absorbing capability may be prevented from lowering. In addition, it may also prevent the polyester resin from being decomposed (to reduce the molecular weight of the resin) owing to the decomposition of the UV absorbent. The b value difference is preferably at most 2.0, more preferably at most 1.0. The UV absorbent having the above-mentioned characteristics includes those having a structural formula of the following general formula (1), as well as benzoxazine-type UV absorbents.

When a UV absorbent having both the above two characteristics is used, then it may exhibit both the two effects. The UV absorbent having the characteristics includes those having a structural formula of the following general formula (1), as well as benzoxazine-type UV absorbents.

The above non-volatile and/or heat-resistant UV absorbent may be kneaded in a material of a support and may be formed into a film. The process readily gives a support having a UV-absorbing capability.

In the invention, a UV absorbent represented by the following general formula (1) is preferably used. The UV absorbent of formula (1) is stable at high temperatures and is hardly volatile, and therefore it is stable and does not thermally decompose at the resin temperature (e.g., at 300° C.) during melt-kneading with a polyester resin, and does not evaporate away immediately after a resin containing it has left from a die part. Accordingly, it may prevent a film from yellowing and its UV-absorbing capability may be prevented from lowering. Needless-to-say, it is effective for simplifying the process using it. 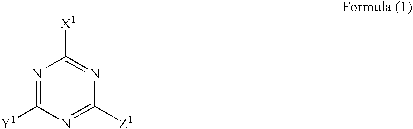
wherein X¹, Y¹ and Z¹ each independently represent a substituted or unsubstituted alkyl, aryl, alkoxy, aryloxy, alkylthio, arylthio or heterocyclic group; and at least one of X¹, Y¹ and Z¹ is a substituent of the following structural formula (A): 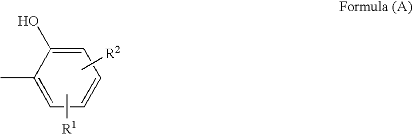
wherein R¹ and R² each independently represent a hydrogen atom, a halogen atom, a substituted or unsubstituted alkyl, alkenyl, aryl, alkoxy, aryloxy, acyloxy, alkylthio, arylthio, amino, acyl, oxycarbonyl, carbamoyl or sulfamoyl group, or a carboxyl group or its salt, or a sulfo group or its salt; and the adjacent R¹ and R² may bond to each other to form a ring.

The alkyl group for X¹, Y¹, Z¹, R¹ and R² in formula (1) and structural formula (A) preferably has from 1 to 20 carbon atoms and may have a substituent [for example, a hydroxyl group, a cyano group, a nitro group, a halogen atom (e.g., chlorine, bromine, fluorine), an alkoxy group (e.g., methoxy, ethoxy, butoxy, octyloxy, phenoxyethoxy), an aryloxy group (e.g., phenoxy), an ester group (e.g., methoxycarbonyl, ethoxycarbonyl, octyloxycarbonyl, dodecyloxycarbonyl), a carbonyloxy group (e.g., ethylcarbonyloxy, heptylcarbonyloxy, phenylcarbonyloxy), an amino group (e.g., dimethylamino, ethylamino, diethylamino), an aryl group (e.g., phenyl, tolyl, 4-methoxyphenyl), a carbonamido group (e.g., methylcarbonylamido, phenylcarbonylamido), a carbamoyl group (e.g., ethylcarbamoyl, phenylcarbamoyl), a sulfonamido group (e.g., methanesulfonamido, benzenesulfonamido), a sulfamoyl group (e.g., butylsulfamoyl, phenylsulfamoyl, methyloctylaminosulfonyl), a carboxyl group and its salt, a sulfo group and its salt]. Concretely, it includes methyl, ethyl, propyl, iso-propyl, n-butyl, sec-butyl, t-butyl, pentyl, t-pentyl, hexyl, octyl, 2-ethylhexyl, t-octyl, decyl, dodecyl, hexadecyl, octadecyl, benzyl, phenethyl, cyclopropyl, cyclopentyl, cyclohexyl and bicyclo[2,2,2]octyl groups, and those having the above-mentioned substituent.

The aryl group for X¹, Y¹, Z¹, R¹ and R² in formula (1) and structural formula (A) preferably has from 6 to 10 carbon atoms, and may have a substituent [for example, an alkyl group (e.g., methyl, ethyl, propyl, iso-propyl, butyl, sec-butyl, t-butyl, pentyl, t-pentyl, octyl, decyl, dodecyl, tetradecyl, hexadecyl), and those mentioned hereinabove as the substituent that the alkyl group may have]. Concretely, the aryl group includes phenyl and naphthyl.

The alkoxy group X¹, Y¹, Z¹, R¹ and R² in formula (1) and structural formula (A) preferably has from 1 to 20 carbon atoms, including, for example, methoxy, ethoxy, butoxy, isobutoxy, n-octoxy, isooctoxy, dodecyloxy, benzyloxy, octadecyloxy. It may be substituted with a substituent such as those mentioned hereinabove as the substituent that the alkyl group may have.

The aryloxy group for X¹, Y¹, Z¹, R¹ and R² in formula (1) and structural formula (A) preferably has from 6 to 10 carbon atoms, including, for example, phenoxy and naphthoxy. It may be substituted with a substituent such as those mentioned hereinabove as the substituent that the aryl group may have.

The alkylthio group for X¹, Y¹, Z¹, R¹ and R² in formula (1) and structural formula (A) preferably has from 1 to 20 carbon atoms, including, for example, methylthio, hexylthio, octylthio, hexadecylthio.

The arylthio group for X¹, Y¹, Z¹, R¹ and R² in formula (1) and structural formula (A) preferably has from 6 to 10 carbon atoms, including, for example, phenylthio, naphthylthio. These alkylthio group and arylthio group may be substituted with a substituent such as those mentioned hereinabove as the substituent that the alkyl group or the aryl group may have.

The heterocyclic group for X¹, Y¹ and Z¹ in formula (1) includes indole, pyrrole, pyrazole, imidazole, pyridine. It may be substituted with a substituent such as those mentioned hereinabove as the substituent that the aryl group may have.

The alkenyl group for R¹ and R² in structural formula (A) preferably has from 3 to 20 carbon atoms, including allyl, 2-butenyl, 3-butenyl, oleyl. It may be substituted with a substituent such as those mentioned hereinabove as the substituent that the alkyl group may have.

The acyloxy group for R¹ and R² in structural formula (A) preferably has from 2 to 20 carbon atoms, including acetyloxy, hexanoyloxy, decanoyloxy, stearoyloxy, benzoyloxy. It may be substituted with a substituent such as those mentioned hereinabove as the substituent that the aryl group may have.

The amino group for R¹ and R² in structural formula (A) is preferably a substituted or unsubstituted amino group having from 0 to 40 carbon atoms, including, for example, unsubstituted amino, methylamino, dimethylamino, diethylamino, octylamino, dihexylamino, distearylamino, diisobutylamino, anilino, diphenylamino, methylphenylamino, formamido, acetylamino, hexanoylamino, decanoylamino, stearoylamino, benzoylamino, methanesulfonamido, ethanesulfonamido, nonanesulfonamido, butanesulfonamido, dodecanesulfonamido, octadecanesulfonamido, benzenesulfonamido, methoxycarbonylamino, phenoxycarbonylamino, carbamoylamino, cyclohexylcarbamoylamino, diethylcarbamoylamino. It may be substituted with a substituent such as those mentioned hereinabove as the substituent that the aryl group may have.

The acyl group for R¹ and R² in structural formula (A) preferably has from 1 to 20 carbon atoms, including acetyl, butanoyl, pivaloyl, octanoyl, hexadecanoyl, benzoyl. It may be substituted with a substituent such as those mentioned hereinabove as the substituent that the aryl group may have.

The oxycarbonyl group for R¹ and R² in structural formula (A) preferably has from 2 to 20 carbon atoms, including methoxycarbonyl, ethoxycarbonyl, butoxycarbonyl, isobutoxycarbonyl, heptyloxycarbonyl, tetradecyloxycarbonyl, octadecyloxycarbonyl, phenoxycarbonyl. It may be substituted with a substituent such as those mentioned hereinabove as the substituent that the aryl group may have.

The carbamoyl group for R¹ and R² in structural formula (A) preferably has from 1 to 20 carbon atoms, including, for example, unsubstituted carbamoyl, methylcarbamoyl, propylcarbamoyl, diethylcarbamoyl, octylcarbamoyl, dodecylcarbamoyl, hexadecylcarbamoyl, octadecylcarbamoyl, phenylcarbamoyl. It may be substituted with a substituent such as those mentioned hereinabove as the substituent that the aryl group may have.

The sulfamoyl group for R¹ and R² in structural formula (A) preferably has from 0 to 20 carbon atoms, including unsubstituted sulfamoyl, ethylsulfamoyl, butylsulfamoyl, heptylsulfamoyl, tetradecylsulfamoyl, dibutylsulfamoyl, octadecylsulfamoyl, phenylsulfamoyl. It may be substituted with a substituent such as those mentioned hereinabove as the substituent that the aryl group may have.

The halogen atom for R¹ and R² in structural formula (A) includes fluorine, chlorine, bromine.

Preferably, the molecular weight of the UV absorbent of formula (1) is at least 400. A UV absorbent having a molecular weight of at least 400 is especially hardly volatile, and it does not soil production lines and may exhibit a necessary UV-absorbing performance even when its amount is small.

One example of benzoxazine is the following molecule (BO-1): 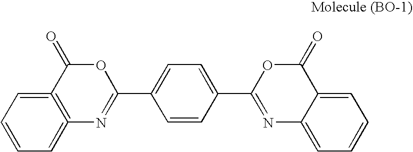
(Method for Producing Polyester)

A method for producing the polyester for use in the invention is not specifically defined, and the polyester may be produced according to the above-mentioned ordinary known polyester production method. For example, it may be produced according to a direct esterification method that comprises direct esterification of a dicarboxylic acid component with a diol component; or an interesterification method that comprises first interesterifying a dialkyl ester as a dicarboxylic acid component with a diol component followed by removing the excessive diol component by heating it under reduced pressure for polymerization. In this case, if desired, an interesterification catalyst or a polymerization catalyst may be used, or a heat-resistant stabilizer may be added to the system. In this case, a metal sulfonate group-having aromatic dicarboxylic acid or polyethylene glycol serving as a copolymerization component may be added to the system after the interesterification step, for polycondensation with it. In any step of the production process, any of discoloration inhibitor, antioxidant, crystal-nucleating agent, lubricant, stabilizer, blocking inhibitor, UV absorbent, viscosity improver, defoaming agent, clarifying agent, antistatic agent, pH-controlling agent, dye, pigment may be added to the system.

(Method for Producing Polyester Film)

A method for producing the polyester film of the invention is described below.

Preferably, the polyester film in the invention is a polyester film formed in a mode of biaxially-stretching film formation.

For obtaining the polyester film, any known method may be employable with no specific limitation thereon. For example, it may be produced according to the method mentioned below. In this case, the machine direction means a film-forming direction (longitudinal direction) and the cross direction means a direction vertical to the film-forming direction.

First, a starting polyester is shaped into pellets, then dried with hot air or in vacuum, melt-extruded, or that is, sheetwise melt-extruded through a T-die, thereafter electrostatically brought into airtight contact with a chill drum, and cooled and solidified thereon to obtain an unstretched sheet. Next, the resulting unstretched sheet is heated via plural rolls and/or a heating device such as an IR heater, within a range of from the glass transition temperature (Tg) of the polyester to (Tg+100° C.) for one-stage or multi-stage machine-direction stretching of the film.

Next, the polyester film stretched in the machine direction as in the above is cross-stretched within a temperature range of from Tg to Tm (melting point), and then heat-set.

The heat-set film is generally cooled to Tg or lower, then the clipped parts of both edges thereof are trimmed away, and the film is then wound up. In this case, the film is preferably subjected to 0.1 to 10% relaxation treatment in the cross direction and/or in the machine direction thereof within a temperature range not higher than the final heat-set temperature but not lower than Tg. The method for cooling and relaxation is not specifically defined, and may be any known one. Especially preferably, however, these treatments are carried out by successively cooling the film within plural temperature ranges, in view of the improvement in the dimensional stability of the film.

The best condition for the heat-setting, cooling and relaxation treatments varies depending on the polyester that constitutes the film, and therefore it may be determined by measuring the physical properties of the obtained, stretched films followed by suitably controlling the condition so as to obtain the films having good characteristics.

The biaxially-stretched polyester film has an excellent mechanical strength as its molecular alignment is sufficiently controlled. The draw ratio in stretching is not specifically defined. Preferably, the film is stretched by from 1.5 times to 7 times in the film-traveling direction and by from 1.5 times to 7 times in the direction vertical to the traveling direction, more preferably by from 2.5 to 5 times or so in both directions. In particular, the biaxially-stretched film of such that the draw ratio in stretching it in the monoaxial direction is controlled to be from 3 to 5 times or so has an extremely excellent mechanical strength and is favorable since the molecular alignment therein is more effectively and more efficiently controlled. However, if the draw ratio is smaller than 1.5 times, then the film could not have a sufficient mechanical strength. On the other hand, if the draw ratio is larger than 7 times, then the film could hardly have a uniform thickness.

As in the above, the biaxially-stretched film may have a low moisture permeability and a sufficient film strength.

The stretched film thus inevitably having an increased birefringence and a sufficient mechanical strength may have an in-plane retardation Re of at least 500 nm, preferably at least 1000 nm, more preferably at least 1500 nm.

In the film production as above, functional layers such as an antistatic layer, a lubricant layer, an adhesive layer and a barrier layer may be formed on the film before and/or after stretching it. In this step, if desired, various surface treatments such as corona discharge treatment, atmospheric plasma treatment and/or chemical treatment may be applied to the film.

As trimmed away, the clipped parts of the film edges may be ground, and optionally granulated and depolymerized/repolymerized, and thereafter may be recycled as a material for films of the same type or for films of different types.

(Film Thickness)

The thickness of the polyester film of the invention is from 5 to 200 μm, preferably from 5 to 100 μm, more preferably from 40 to 100 μm.

(Moisture Permeability)

The moisture permeability of the polyester film of the invention is preferably at most 700 g/m²·day, more preferably at most 300 g/m²·day, most preferably at most 100 g/m²·day

Having a low moisture permeability, the film hardly causes a problem of light leakage and a problem of polarization depression even in high-humidity/low-humidity environments, when worked into polarizers and used in liquid-crystal display devices.

(Modulus of Elasticity)

Preferably, the modulus of elasticity of the polyester film of the invention is from 3 to 7 GPa.

Having a modulus of elasticity falling within the range, the film hardly causes a problem of light leakage and a problem of polarization depression even in high-humidity/low-humidity environments, when worked into polarizers and used in liquid-crystal display devices.

(Water Content)

Preferably, the water content of the polyester film of the invention is at most 1%.

Having a water content falling within the range, the film hardly causes a problem of light leakage and a problem of polarization depression even in high-humidity/low-humidity environments, when worked into polarizers and used in liquid-crystal display devices.

(Layer Constitution)

The polyester film of the invention may be a single-layered film of the above polyester film alone, but may also be a multi-layered film of plural resin layers that contains at least one layer of the above-mentioned polyester, not detracting from the effect of the invention. When the above polyester layer is A and the other resin layers are B and C, then, for example, the film may have a constitution of A/B, A/B/A, B/A/B or B/A/C. Needless-to-say, the film may have a four-layered or more multi-layered structure. In such a multi-layered structure, for example, a film having a high strength and a high water-barrier capability may be laminated as the core layer or an outer layer, and plural functions may be simultaneously imparted to the multi-layered film.

(Addition of Fine Particles)

In case where fine particles of a mat agent or the like are added to the film for imparting lubricity thereto, they may be added to only the outermost layer to attain their effect. Accordingly, the function may be given to the film not detracting from the film transparency.

(Fine Particles to be Added)

The fine particles to be added are not specifically defined. For example, fine particles of an inorganic compound or fine particles of an organic compound are usable herein.

The inorganic compound is preferably a silicon-containing compound, silicon dioxide, aluminium oxide, zirconium oxide, calcium carbonate, talc, clay, calcined kaolin, calcined calcium silicate, calcium silicate hydrate, aluminium silicate, magnesium silicate and calcium phosphate; more preferably a silicon-containing inorganic compound and zirconium oxide; even more preferably silicon dioxide.

Commercial products of fine particles of silicon dioxide are usable herein, for example, Aerosil R972, R972V, R974, R812, 200, 200V, 300, R202, OX50, TT600 (all by Nippon Aerosil).

Commercial products of fine particles of zirconium oxide are also usable, for example, Aerosil R976 and R811 (all by Nippon Aerosil).

As the organic compound, for example, preferably used are polymers such as silicone resin, fluororesin and acrylic resin, and more preferred is silicone resin.

As the silicone resin, especially preferred is a three-dimensional network structure-having silicone resin, for example, commercial products such as Tospearl 103, 105, 108, 120, 145, 3120 and 240 (all trade names by Toshiba Silicone).

(Light-Scattering Layer)

The light-scattering layer is formed for the purpose of imparting hard-coating capability to the film of a polyester resin for use in the invention, for reducing the rainbow-like unevenness caused by birefringent interference occurring in the film, by light scattering on the film, and preferably for improving the scratch resistance of the film.

For forming the light-scattering layer, employable is any known method of, for example, a method of laminating a mat-like profiling film that has a fine surface roughness on the resin film, as in JP-A 6-16851; a method of forming the layer through curing shrinkage of a ionizing radiation-curable resin based on the difference in the ionizing radiation dose, as in JP-A 2000-206317; a method of roughening the surface of a coating film by gelling and solidifying light-transmissive particles and a light-transmissive resin based on the reduction in the mass of the good solvent for the light-transmissive resin in drying, as in JP-A 2000-338310; and a method of forming surface roughness through application of external pressure, as in JP-A 2000-275404.

The light-scattering layer for use in the invention is preferably such that it comprises a binder capable of imparting a hard-coating capability to the layer, light-transmissive particles for imparting a light-scattering capability thereof, and a solvent as the indispensable ingredients thereof and that the projections of the light-transmissive particles themselves or the projections formed by the aggregations of plural particles may form a surface roughness of the layer.

The light-scattering layer formed through dispersion of mat particles comprises a binder and light-transmissive particles dispersed in the binder. The light-scattering layer preferably has both a light-scattering capability and a hard-coating capability.

(Binder in Light-Scattering Layer)

The light-scattering layer in the invention may be formed through crosslinking or polymerization of an ionizing radiation-curable compound. Specifically, a coating composition that contains an ionizing radiation-curable polyfunctional monomer or polyfunctional oligomer as a binder is applied onto a transparent support, and the polyfunctional monomer or polyfunctional oligomer therein is crosslinked or polymerized to thereby form a layer on the support.

The functional group of the ionizing radiation-curable polyfunctional monomer or polyfunctional oligomer is preferably a photopolymerizing, electron ray-polymerizing or radiation-polymerizing group, more preferably a photopolymerizing functional group.

The photopolymerizing functional group includes a an unsaturated polymerizing functional group, such as a (meth)acryloyl group, a vinyl group, a styryl group, an allyl group, and is especially preferably a (meth)acryloyl group.

Examples of the photopolymerizing functional group-having photopolymerizing polyfunctional monomer are the following:

Alkylene glycol (meth)acrylic diesters such as neopentylglycol acrylate, 1,6-hexanediol (meth)acrylate, propylene glycol di(meth)acrylate;

Polyoxyalkylene glycol (meth)acrylic diesters such as triethylene glycol di(meth)acrylate, dipropylene glycol di(meth)acrylate, polyethylene glycol di(meth)acrylate, polypropylene glycol di(meth)acrylate;

Polyalcohol (meth)acrylic diesters such as pentaerythritol di(meth)acrylate;

Ethylene oxide or propylene oxide adduct (meth)acrylic diesters such as 2,2-bis{4-(acryloxy.diethoxy)phenyl}propane, 2,2-{4-(acryloxy.polypropoxy)phenyl}propane.

In addition, epoxy (meth)acrylates, urethane (meth)acrylates, polyester (meth)acrylates are also preferred for the photopolymerizing polyfunctional monomer.

Above all, esters of polyalcohol and (meth)acrylic acid are preferred. More preferred are a polyfunctional monomer having at least three (meth)acryloyl groups in one molecule. Concretely, it includes trimethylolpropane tri(meth)acrylate, trimethylolethane tri(meth)acrylate, 1,2,4-cyclohexane tetra(meth) acrylate, pentaglycerol triacrylate, pentaerythritol tetra(meth)acrylate, pentaerythritol tri(meth)acrylate, (di)pentaerythritol triacrylate, (di)pentaerythritol pentaacrylate, (di)pentaerythritol tetra(meth)acrylate, (di)pentaerythritol hexa(meth)acrylate, tripentaerythritol triacrylate. In this description, “(meth)acrylate”, “(meth)acrylic acid”, and “(meth)acryloyl” mean “acrylate or methacrylate”, “acrylic acid or methacrylic acid”, and “acryloyl or methacryloyl”, respectively.

A monomer binder having a different refractive index may be used for controlling the refractivity of each layer. Examples of a high-refractivity monomer include bis(4-methacryloylthiophenyl) sulfide, vinylnaphthalene, vinyl phenyl sulfide, 4-methacryloxyphenyl-4′-methoxyphenyl thioether.

In addition, dendrimers as in JP-A 2005-76005, 2005-36105; and norbornene ring-containing monomers as in JP-A 2005-60425 are also usable herein.

Two or more different types of polyfunctional monomers may be used, as combined.

(Initiator)

Polymerization of the ethylenic unsaturated group-having monomer may be attained through irradiation with ionizing radiations or under heat, in the presence of a photoradical initiator or a thermal radical initiator.

Preferably, a photopolymerization initiator is used for the polymerization of a photopolymerizing polyfunctional monomer. The photopolymerization initiator is preferably a photoradical polymerization initiator and a photocationic polymerization initiator, more preferably a photoradical polymerization initiator.

(Photoinitiator)

The photoradical initiator includes acetophenones, benzoins, benzophenones, phosphine oxides, ketals, anthraquinones, thioxanthones, azo compounds, peroxides (e.g., JP-A 2001-139663), 2,3-dialkyldione compounds, disulfide compounds, fluoroamine compounds, aromatic sulfoniums, rofin dimers, onium salts, borates, active esters, active halogens, inorganic complexes, coumarins.

Examples of the acetophenones include 2,2-dimethoxyacetophenone, 2,2-diethoxyacetophenone, p-dimethylacetophenone, 1-hydroxy-dimethylphenyl ketone, 1-hydroxy-dimethyl-p-isopropylphenyl ketone, 1-hydroxycyclohexylphenyl ketone, 2-methyl-4-methyl thio-2-morpholinopropiophenone, 2-benzyl-2-dimethylamino-1-(4-morpholinophenyl)-butanone, 4-phenoxydichloroacetophenone, 4-t-butyl-dichloroacetophenone.

Examples of the benzoins include benzoin, benzoin methyl ether, benzoin ethyl ether, benzoin isopropyl ether, benzyldimethyl ketal, benzoin benzenesulfonates, and benzoin toluenesulfonates.

Examples of the benzophenones include benzophenone, hydroxybenzophenone, 4-benzoyl-4′-methyldiphenyl sulfide, 2,4-dichlorobenzophenone, 4,4-dichlorobenzophenone, p-chlorobenzophenone, 4,4′-dimethylaminobenzophenone (Michler's ketone), 3,3′,4,4′-tetra(t-butylperoxycarbonyl)benzophenone.

The borates include, for example, organic borates as in Japanese Patent No. 2764769, JP-A 2002-116539; and Kuns, Martin “Rad Tech' 98, Proceeding April, pp. 19-22, 1998, Chicago”. For example, the compounds described in JP-A 2002-116539, paragraphs [0022] to [0027] are referred to. Other organic boron compounds usable herein are organic boron-transition metal coordination complexes such as those in JP-A 6-348011, 7-128785, 7-140589, 7-306527, 7-292014. Their concrete examples are ion complexes with cationic dyes.

Examples of phosphine oxides include 2,4,6-trimethylbenzoyldiphenylphosphine oxide.

Examples of the active esters include 1,2-octanedione, 1-[4-(phenylthio)-2-(O-benzoyloxime)], sulfonates, cyclic active ester compounds.

Concretely, preferred are compounds 1 to 21 described in Examples in JP-A 2000-80068.

Examples of the onium salts are aromatic diazonium salts, aromatic iodonium salts, aromatic sulfonium salts.

Examples of the active halogens are concretely those described in Wakabayashi et al., “Bull. Chem. Soc., Japan”, Vol. 42, p. 2924 (1969); U.S. Pat. No. 3,905,815; JP-A 5-27830; M. P. Hutt, “Journal of Heterocyclic Chemistry”, Vol. 1 (No. 3) (1970). Especially referred to are trihalomethyl group-substituted oxazole compounds and s-triazine compounds. More preferred are s-triazine derivatives with at least one mono-, di- or tri-halogen-substituted methyl group bonding to the s-triazine ring. Concrete examples are S-triazines and oxadiazole compounds, including 2-(p-methoxyphenyl)-4,6-bis(trichloromethyl)-s-triazine, 2-(p-methoxyphenyl)-4,6-bis(trichloromethyl)-s-triazine, 2-(p-styrylphenyl)-4,6-bis(trichloromethyl-s-triazine, 2-(3-Br-4-di(ethyl acetate)amino)phenyl)-4,6-bis(trichloromethyl)-s-triazine, 2-trihalomethyl-5-(p-methoxyphenyl)-1,3,4-oxadiazole. Concretely, especially preferred are the compounds described in JP-A 58-15503, pp. 14-30; the compounds described in JP-A 55-77742, pp. 6010; the compounds No. 1 to No. 8 described in JP-B 60-27673, p. 287; the compounds No. 1 to No. 17 described in JP-A 60-239736, pp. 443-444; and the compounds Nos. 1 to 19 in U.S. Pat. No. 4,701,399.

Examples of the inorganic complexes include (η⁵-2,4-cyclopentadien-1-yl)-bis(2,6-difluoro-3-(1H-pyrrol-1-yl)-phenyl)titanium.

Examples of the coumarins include 3-ketocoumarin.

The initiators may be used singly or as their mixture.

Various examples are described in The Latest UV Curing Technology, by the Association of Technical Information, 1991, p. 159; and Kiyoshi Kato, UV-Curable System, issued by the General Technology Center, 1989, pp. 65-148, and they are useful in the invention.

Preferred examples of commercially-available photoradical polymerization initiators are Nippon Kayaku's KAYACURE (DETX-S, BP-100, BDMK, CTX, BMS, 2-EAQ, ABQ, CPTX, EPD, ITX, QTX, BTC, MCA); Ciba Speciality Chemicals' IRGACURE (651, 184, 500, 819, 907, 369, 1173, 1870, 2959, 4265, 4263), Sartomer's ESACURE (KIP100F, KB1, EB3, BP, X33, KT046, KT37, KIP150, TZT), and their combinations.

Preferably, the amount of the photopolymerization initiator to be sued is from 0.1 to 15 parts by mass, relative to 100 parts by mass of the polyfunctional monomer, more preferably from 1 to 10 parts by mass.

(Photosensitizer)

In addition to the photopolymerization initiator, also usable herein is a photosensitizer. Examples of the photosensitizer are n-butylamine, triethylamine, tri-n-butyl phosphine, Michler's ketone and thioxanthone.

In addition one or more promoters such as azide compounds, thiourea compounds and mercapto compounds may also be used as combined with the above.

Commercially-available photosensitizers are Nippon Kayaku's KAYACURE (DMBI, EPA).

(Thermal Initiator)

The thermal radical initiator usable herein includes organic or inorganic peroxides, organic azo and diazo compounds.

Concretely, the organic peroxides include benzoyl peroxide, halogenobenzoyl peroxide, lauroyl peroxide, acetyl peroxide, dibutyl peroxide, cumenehydroperoxide, butylhydroperoxide; and the inorganic peroxides include hydrogen peroxide, ammonium persulfate, potassium persulfate; the azo compounds include 2,2′-azobis(isobutyronitrile), 2,2′-azobis(propionitrile), 1,1′-azobis(cyclohexanecarbonitrile); and the diazo compounds include diazoaminobenzene, p-nitrobenzene-diazonium.

(Light-Transmissive Particles)

The light-transmissive particles may be either organic particles or inorganic particles. Plastic beads are preferred for the light-transmissive particles, more preferred are those having a high transparency of such that the refractivity difference between the particles and the binder is from 0.01 to 0.3.

The organic particles usable herein are polymethyl methacrylate particles (refractive index, 1.49), crosslinked poly(acryl-styrene) copolymer particles (refractive index, 1.54), melamine resin particles (refractive index, 1.57), polycarbonate particles (refractive index, 1.57), polystyrene particles (refractive index, 1.60), crosslinked polystyrene particles (refractive index, 1.61), polyvinyl chloride particles (refractive index, 1.60), benzoguanamine-melamine-formaldehyde particles (refractive index, 1.68).

The inorganic particles usable herein are silica particles (refractive index, 1.44), alumina particles (refractive index, 1.63), zirconia particles, titania particles, and hollowed or porous inorganic particles.

Above all, preferred for use herein are crosslinked polystyrene particles, crosslinked poly(meth)acrylate particles, crosslinked poly(acryl-styrene) particles. The refractive index of the binder may be controlled in accordance with the refractive index of the light-transmissive particles selected from those mentioned above, whereby the intended internal haze, surface haze and center line average height of the film may be attained.

The refractive index of the binder (light-transmissive resin) and the light-transmissive particles is preferably from 1.45 to 1.70, more preferably from 1.48 to 1.65. For making them have a refractive index that falls within the above range, the type and the blend ratio of the binder and the light-transmissive particles may be suitably selected. Anyone skilled in the art could readily know how to select them through experiments.

The refractive index of the binder may be directly measured with an Abbe's refractiometer, or may be quantitatively determined through reflection spectrometry or spectral ellipsometry. The refractive index of the light-transmissive particles may be determined as follows: The light-transmissive particles are dispersed in a mixture of two solvents, which is prepared by varying the blend ratio of two solvents having a different refractive index so as to vary the refractive index of the resulting mixture, in an equimolar ratio, then the turbidity of the resulting dispersion is measured, and the refractive index of the solvent that gives a minimum turbidity is measured with an Abbe's refractiometer.

The above-mentioned light-transmissive particles may readily precipitate in a binder, and an inorganic filler such as silica may be added thereto for preventing the precipitation. When its amount is larger, then the inorganic filler may be more effective for preventing the light-transmissive particles from precipitating, but may have some negative influence of the transparency of the coating film. Accordingly, preferably, an inorganic filler having a particle size of at most 0.5 μm is added in an amount of less than 0.1% by mass or so of the binder in such a degree that it does not detract from the transparency of the coating film.

Preferably, the mean particle size of the light-transmissive particles is from 0.5 to 10 μm, more preferably from 2.0 to 8.0 μm. When the mean particle size is at least 0.5 μm but at most 10 μm, then it is desirable since the particles do not cause display of blurred images or letters and do not cause any other problems of film curling or film cost increase.

Two or more different types of light-transmissive particles having a different particle size may be used, as combined. Light-transmissive particles having a larger particle size may be effective for imparting light-scatterability of the film, and those having a smaller particle size may be effective for reducing the surface rough feel of the film.

The light-transmissive particles may be added to the coating layer in an amount of from 3 to 30% by mass of the overall solid content of the coating liquid, more preferably in an mount of from 5 to 20% by mass. When the amount is smaller than 3% by mass, then the particles may be ineffective; but when larger than 30% by mass, then they may cause a problem of blurred images and a problem of cloudy or glaring surfaces.

Preferably, the density of the light-transmissive particles is from 10 to 1000 mg/m³, more preferably from 100 to 700 mg/m³.

(Method of Preparation and Classification of Light-Transmissive Particles)

For producing the light-transmissive particles, employable is any method of suspension polymerization, emulsion polymerization, soap-free emulsion polymerization, dispersion polymerization or seed polymerization. For these production methods, for example, referred to are the methods described in Experimental Method of Polymer Synthesis (Takayuki Ohtsu & Masaetu Kinoshita, by Kagaku Dojin), p. 236, pp. 146-147; Synthetic Polymers, Vol. 1, pp. 246-290; ibid., Vol. 3, pp. 1-108; Japanese Patents 2543503, 3508304, 2746275, 3521560, 3580320; JP-A 10-1561, 7-2908, 5-297506, 2002-145919.

Regarding the particle size distribution thereof, the light-transmissive particles are preferably mono-dispersed particles in point of controlling the haze value and the diffusibility thereof and from the viewpoint of the uniformity of the coating surface profile. For example, when large particles having a particle size larger by 20% than the mean particle size of whole particles are referred to as coarse particles, then it is desirable that the proportion of such coarse particles in the light-transmitting particles for use herein is at most 1% by number of the overall number of the particles, more preferably at most 0.1%, even more preferably at most 0.01%. One effective method for obtaining the particles having such a particle size distribution comprises classification after preparation or synthetic reaction of the particles. Increasing the frequency of classification or increasing the intensity thereof may give particles having a desired particle size distribution.

For the classification, preferably employed is a method of pneumatic classification, a method of centrifugal classification, a method of precipitating classification, a method of filtrating classification, or a method of electrostatic classification.

Two or more different types of light-transmissive particles having a different particle size may be combined for use herein. The light-transmissive particles having a larger particle size may impart light-scatterability to the film; and the light-transmissive particles having a smaller particle size may impart any other optical characteristics thereto. For example, in case where a light-scattering antireflection film is stuck to a high-definition display of 133 ppi or more, then there may occur some malfunction in display image quality, referred to as “glaring”. “Glaring” may result from the loss of brightness uniformity since the pixels may be enlarged or reduced owing to the surface roughness of the light-scattering antireflection film, and it may be significantly overcome by combining the light-transmissive particles for light-scatterability impartation with those having a smaller particle size than the former and having a refractive index differing from that of the binder.

(Formation of Light-Scattering Layer through Spinodal Decomposition)

Another example of the method for forming the light-scattering layer than that of using light-transmissive particles for expressing the light-scatterability comprises forming the light-scattering layer through Spinodal decomposition of plural polymers.

The light-scattering layer formed through Spinodal decomposition comprises plural polymers each having a different refractive index, and generally in the service atmosphere (especially at room temperature of from about 10 to 30° C. or so), it forms a phase-separated structure having at least a co-continuous phase structure. The co-continuous phase structure is formed through Spinodal decomposition from a liquid phase containing plural polymers (this is a liquid phase at room temperature, for example, in the form of a mixed liquid or solution). The co-continuous phase structure generally contains plural polymers, and is formed from a composition capable of forming a liquid phase at room temperature (e.g., mixed liquid or solution) through Spinodal decomposition via solvent evaporation. The light-scattering layer of the type is formed from a liquid phase, and therefore has a uniform and fine co-continuous phase structure. When the light-transmissive and light-scattering layer of the type is sued, then the incident light may substantially isotropically scatter, and the transmitted scattered light may be oriented in a specific direction. Accordingly, the layer may satisfy both high light-scatterability and light orientation.

For increasing the light-scatterability, the plural polymers are preferably so combined that the refractivity difference between them could be, for example, from 0.01 to 0.2 or so, more preferably from 0.1 to 0.15 or so. When the refractivity difference is smaller than 0.01, then the intensity of the transmitted and scattered light may lower; but when the refractivity difference is larger than 0.2, then the transmitted and scattered light could not enjoy high orientation.

The plural polymers may be suitably combined, as selected from, for example, styrenic resins, (meth)acrylic resins, vinyl ester-type resins, vinyl ether-type resins, halogen-containing resins, olefinic resins (including alicyclic olefinic resins), polycarbonate-type resins, polyester-type resins, polyamide-type resins, thermoplastic polyurethane resins, polysulfone-type resins (e.g., polyether sulfone, polysulfone), polyphenylene ether-type resins (e.g., 2,6-xylenol polymer), cellulose derivatives (e.g., cellulose esters, cellulose carbonates, cellulose ethers), silicone resins (e.g., polydimethylsiloxane, polymethylphenylsiloxane), rubbers and elastomers (e.g., dienic rubbers such as polybutadiene, polyisoprene; styrene-butadiene copolymer, acrylonitrile-butadiene copolymer, acrylic rubber, urethane rubber, silicone rubber).

Preferred polymers include, for example, styrenic resins (meth)acrylic resins, vinyl ester-type resins, vinyl ether-type resins, halogen-containing resins, alicyclic olefinic resins, polycarbonate-type resins, polyester-type resins, polyamide-type resins, cellulose derivatives, silicone-type resins, and rubbers and elastomers. As plural polymers, generally used are resins that are amorphous and capable of dissolving in an organic solvent (especially, a common solvent capable of dissolving plural polymers). In particular, preferred are resins having good shapability and film formability, and good transparency and weather resistance, for example, styrenic resins, (meth)acrylic resins, alicyclic olefinic resins, polyester-type resins, cellulose derivatives (e.g., cellulose esters).

These plural polymers may be combined in any desired manner for use herein. For example, in combining plural polymers, at least one polymer may be a cellulose derivative, especially a cellulose ester (e.g., C₂₋₄ alkylcarboxylate of cellulose, such as cellulose diacetate, cellulose triacetate, cellulose acetate propionate, cellulose acetate butyrate), and it may be combined with another polymer.

The glass transition temperature of the polymer may be, for example, selected from a range of from −100° C. to 250° C., preferably from −50 to 230° C., more preferably from 0 to 200° C. or so (for example, from 50 to 180° C. or so). From the viewpoint of the strength and the toughness of the light-scattering layer, it is advantageous that at least one of the constitutive polymers has a glass transition temperature of 50° C. or higher (for example, from 70 to 200° C. or so), preferably 100° C. or higher (for example, from 100 to 170° C. or so). The weight-average molecular weight of the polymer may be selected from a range of, for example, at most 1,000,000 (from 10,000 to 1,000,000 or so), preferably from 10,000 to 700,000 or so.

When a wet process of Spinodal decomposition of vaporizing a solvent from a liquid phase that contains plural polymers is employed, a substantially isotropic co-continuous phase structure-having light-scattering layer may be formed, principally irrespective of the presence or absence of the compatibility of the plural polymers with each other. Accordingly, plural polymers that are compatible with each other may be combined to constitute the layer, but generally in many cases, non-compatible (phase-separating) plural polymers are often combined for easy control of the phase separation structure through Spinodal decomposition thereby to efficiently form the co-continuous phase structure.

The plural polymers may comprise a combination of a first polymer and a second polymer, in which the first polymer and the second polymer may be composed of a single resin or plural resins. The combination of the first polymer and the second polymer is not specifically defined. For example, when the first polymer is a cellulose derivative (e.g., cellulose ester such as cellulose acetate propionate), then the second polymer may be any of a styrenic resin (e.g., polystyrene, styrene-acrylonitrile copolymer), a (meth)acrylic resin (e.g., polymethyl methacrylate), an alicyclic olefinic resin (e.g., polymer from norbornene monomer), a polycarbonate-type resin, or a polyester-type resin (e.g., the above-mentioned poly-C₂₋₄ alkylene arylate-type copolyester).

The ratio of the first polymer to the second polymer may be, for example, former/latter=from 10/90 to 90/10 (by weight) or so, preferably from 20/80 to 80/20 (by weight) or so, more preferably from 30/70 to 70/30 (by weight) or so, still more preferably from 40/60 to 60/40 (by weight) or so. When the proportion of one polymer is too much, then the separated phase-to-phase ratio may be unbalanced, and the intensity of the scattered light may lower. In case where three or more plural polymers form the light-scattering layer, then the content of each polymer may be selected from a range of generally from 1 to 90% by mass e.g., from 1 to 70% by mass, preferably from 5 to 70% by mass, more preferably from 10 to 70% by mass) or so.

The light-scattering layer has at least a co-continuous phase structure. The co-continuous phase structure may be referred to as a co-continuous structure or a three-dimensionally continuous or connected structure, and this means a structure comprising at least two constitutive polymer phases continuing to each other (e.g., network structure). The light-scattering layer shall have at least a co-continuous phase layer, and may have a structure comprising both a co-continuous phase structure and a droplet phase structure (independent or isolated phase structure) mixed together. In Spinodal decomposition, when a co-continuous phase structure is formed through promotion of phase separation, and when the phase separation is further promoted, then the continuous layer may become discontinuous owing to its own surface tension to give a droplet phase structure (sea-island structure of independent phases such as spherical or true-spherical phases). Accordingly, depending on the degree of phase separation, an intermediate structure between the co-continuous phase structure and the droplet phase structure, or that is, a phase structure in the course of changing from the above co-continuous phase to a droplet phase may be formed. The intermediate structure is also within the scope of the co-continuous phase structure. When the phase separation structure is a mixed structure of the co-continuous phase structure and the droplet structure, the proportion of the droplet phase (independent polymer phase) in the mixed structure may be, for example, at most 30% (by volume), preferably at most 10% (by volume). The profile of the co-continuous phase structure is not specifically defined, and it may be a network structure, especially a random network structure.

The anisotropy of the co-continuous phase structure is generally reduced in the face of the light-scattering layer, and the structure is substantially isotropic. The wording “isotropic” means that the mean phase-to-phase distance in the co-continuous phase structure is substantially the same in every direction in the face of the light-scattering layer.

The co-continuous phase structure generally has regularity in the phase-to-phase distance (distance between the same phases). Accordingly, the light having entered the light-scattering layer gives a transmitted and scattered light as oriented in a specific direction owing to Bragg reflection. Therefore, when the film of the invention is mounted on a reflection-type liquid-crystal display device, the transmitted and scattered light may be oriented in a predetermined direction, and accordingly the display panel may be highly brightened. This means that the invention can solve the problems that any conventional, particle dispersion-type, transmission-type light-scattering layer could not solve, or that is, the film of the invention can evade the problem of reflection of light source (e.g., fluorescent lamp) onto display panels.

The mean phase-to-phase distance in the co-continuous phase in the light-scattering layer may be, for example, from 0.5 to 20 μm (e.g., from 1 to 20 μm), preferably from 1 to 15 μm (e.g., from 1 to 10 μm) or so. When the mean phase-to-phase distance is too small, then the layer could hardly give a high scattered light intensity; but when the mean phase-to-phase distance is too large, then the orientation of the transmitted scattered light may lower.

The mean phase-to-phase distance in the co-continuous layer may be computed from the data in the microscopic picture (e.g., transmissive microscopic, retardation microscopic, or confocal laser microscopic picture) of the light-scattering layer. In addition, in the same manner as that for evaluation of scattered light orientation mentioned hereinunder, the scattering angle θ that gives a maximum scattered light intensity is measured, and the mean phase-to-phase distance d in the co-continuous phase may be computed according to the Bragg reflection condition formula mentioned below:
2d·sin(θ/2)=λ
wherein d is the mean phase-to-phase distance in the co-continuous layer; θ is the scattering angle; and λ is the wavelength of light.
(Formation of Light-Scattering Layer by Embossing)

Still another method of forming a light-scattering layer than that for expressing the light-scatterability by the use of light-transmissive particles comprises forming a light-scattering layer in according to an embossing process.

The light-scattering layer formed according to an embossing process is such that the light-scattering layer is substantially formed of an ionizing radiation-curable resin composition or a thermosetting resin composition shaped by a mat-like profiling film that has fine projections and depressions in its surface.

Preferred examples of the production method for the light-scattering layer are as follows: In case where the resin is an ionizing radiation-curable resin composition, the ionizing radiation-curable resin composition is applied onto a transparent film, then, while the coating film of the ionizing radiation-curable resin composition is still uncured, a mat-like profiling film that has fine projections and depressions in its surface is laminated on the coating film, and thereafter ionizing radiations are applied to the coating film laminated with the profiling film, whereby the coating film of the ionizing radiation-curable resin composition is cured, and then the profiling film is peeled from the coating film of the ionizing radiation-curable resin, thereby giving the intended light-scattering layer.

In case where the resin is a thermosetting resin composition, the thermosetting resin composition is applied onto a transparent film, then, while the coating film of the thermosetting resin composition is still uncured, a mat-like profiling film that has fine projections and depressions in its surface is laminated on the coating film, and thereafter the coating film laminated with the profiling film thereon is heated and cured, and then the profiling film is peeled from the coating film of the thermosetting resin composition, thereby giving the intended light-scattering layer.

When the profiling film is laminated on the uncured coating film of an ionizing radiation-curable resin composition, and when the resin for the film is diluted with a solvent, then the solvent is first evaporated away and then the profiling film may be laminated on the resin film; and when the resin is not diluted with a solvent, then the profiling film may be directly laminated on the resin film.

The film-forming component of the ionizing radiation-curable resin composition to be used for the light-scattering layer to be formed according to the embossing process preferably comprises an acrylate-type functional group-having oligomer or prepolymer, for example, a polyester resin, a polyether resin, an acrylic resin, an epoxy resin, an urethane resin, an alkyd resin, a spiroacetal resin, a polybutadiene resin, a polythiol-polyene resin or a (meth)acrylate of a polyfunctional compound such as a polyalcohol that has a relatively low molecular weight, and, as a reactive diluent, a monofunctional monomer such as ethyl (meth)acrylate, ethylhexyl (meth)acrylate, styrene, methylstyrene, N-vinylpyrrolidone, as well as a polyfunctional monomer such as trimethylolpropane tri(meth)acrylate, hexanediol (meth)acrylate, tripropylene glycol di(meth)acrylate, diethylene glycol di(meth)acrylate, pentaerythritol tri(meth)acrylate, dipentaerythritol hexa(meth)acrylate, 1,6-hexanediol di(meth)acrylate, neopentyl glycol di(meth)acrylate, both in a relatively large amount thereof.

More preferably used herein is a mixture of polyester acrylate and polyurethane acrylate. The reason is because a coating film of polyester acrylate extremely hard and the polymer is suitable for forming a hard coat layer, but the polyester acrylate film is poorly resistant to impact by itself and is brittle. Therefore, for making the coating film resistant to impact and flexible, polyurethane acrylate is combined with polyester acrylate. The proportion of polyurethane acrylate may be at most 300 parts by weight relative to 100 parts by weight of polyester acrylate. When the value is larger than the range, the coating film may be too soft and may lose hardness.

In order that the above ionizing radiation-curable resin composition could be a UV-curable resin composition, a photopolymerization initiator and a photosensitizer may be added thereto. The initiator includes acetophenones, benzophenones, Michler's benzoyl benzoate, α-amyloxime ester, tetramethylthiuram monosulfide, thioxanthones; and the sensitizer includes n-butylamine, triethylamine, tri-n-butyl phosphine. Preferably, urethane acrylate as an oligomer and dipentaerythritol hexa(meth)acrylate as a monomer are mixed.

The coating composition for forming coating film that has both light scatterability and hard coat performance (scratch resistance) may contain a solvent-evaporable resin in an amount of from 10 parts by weight to 100 parts by weight relative to 100 parts by weight of the ionizing radiation-curable resin therein. A thermoplastic resin may be mainly used for the solvent-evaporable resin. Any ordinary solvent-evaporable thermoplastic resin may be added to the ionizing radiation-curable resin. In particular, when a mixture of polyester acrylate and polyurethane acrylate is used for the ionizing radiation-curable resin, then the solvent-evaporable resin to be combined with it is preferably polymethyl methacrylate or polybutyl methacrylate as it may keep high hardness of the coating film. In addition, in this case, since the refractive index of the additional resin is near to that of the essential ionizing radiation-curable resin, the additional resin does not detract from the transparency of the coating film, and is therefore advantageous in point of the transparency of the coating film, especially since the haze value of the coating film is low and the light transmittance thereof is high and since the compatibility of the two resins is good.

(Thickness and Other Properties of Light-Scattering Layer)

The thickness of the light-scattering layer is preferably from 1 to 25 μm, more preferably from 2 to 15 μm. If too thin, the hardness of the layer may be poor; but if too thick, the layer may curl and may be brittle, therefore detracting from the workability of the film. Accordingly, the thickness of the layer preferably falls within the range.

When the rainbow-like unevenness is prevented by the light-scattering layer, then the total haze of the layer is preferably from 10% to 80%, more preferably from 20% to 70%. Also preferably, the surface haze of the layer is from 0.3% to 70%, more preferably from 0.3% to 20%.

In case where the pattern or color unevenness, the brightness unevenness and the glaring of liquid-crystal panels are prevented by the internal scattering through the hard coat layer and where the layer is given a function of enlarging a viewing angle by the scattering therethrough, the internal haze (obtained by subtracting the surface haze from the total haze) of the layer is preferably from 10% to 80%, more preferably from 15% to 70%, most preferably from 20% to 60%.

The film of the invention may be freely controlled in point of its surface haze and internal haze in accordance with its object.

On the other hand, the center line average height (Ra) of the light-scattering layer is preferably within a range of from 0.01 to 0.40 μm, more preferably within a range of from 0.05 to 0.20 μm. When it is higher than 0.40 μm, then it may cause a problem of glaring and surface whitening upon external light reflection on the film. Preferably, the degree of transmitted image sharpness is from 5 to 60%.

The hardness of the light-scattering layer is preferably at least 3 H in a pencil hardness test, more preferably at least 4 H, most preferably at least 5 H.

(High-Refractivity Layer, Middle-Refractivity Layer)

The film of the invention may have a high-refractivity layer and a middle-refractivity layer to increase its antireflective performance.

In this description, both the high-refractivity layer and the middle-refractivity layer are referred to as a generic term “high-refractivity layer”. In this description, the wordings “high”, “middle” and “low” in the high-refractivity layer, the middle-refractivity layer and the low-refractivity layer indicate the relative level of refractivity among those layers. Regarding the relation of those layers to a transparent support, their refractivity preferably satisfies a condition of transparent support>low-refractivity layer, and high-refractivity layer>transparent support.

In this description, all the high-refractivity layer, the middle-refractivity layer and the low-refractivity layer may be referred to as a generic term “antireflection layer”.

When an antireflection film is constructed by forming a low-refractivity layer on a high-refractivity layer, then the refractive index of the high-refractivity layer is preferably from 1.55 to 2.40, more preferably from 1.60 to 2.20, even more preferably from 1.65 to 2.10, most preferably from 1.80 to 2.00.

In case where a middle-refractivity layer, a high-refractivity layer and a low-refractivity layer are formed on a support to be nearer to the support in that order to construct an antireflection film, the refractive index of the high-refractivity layer is preferably from 1.65 to 2.40, more preferably from 1.70 to 2.20. The refractive index of the middle-refractivity layer is so controlled that it could be between the refractive index of the low-refractivity layer and that of the high-refractivity layer. Preferably, the refractive index of the middle-refractivity layer is from 1.55 to 1.80.

Inorganic particles comprising TiO₂ as the essential ingredient thereof for use in the high-refractivity layer and the middle-refractivity layer may be in the form of their dispersion in forming the high-refractivity layer and the middle-refractivity layer containing them.

The inorganic particles may be dispersed in a dispersion medium in the presence of a dispersant.

The high-refractivity layer and the middle-refractivity layer may be formed preferably as follows: Inorganic particles are dispersed in a dispersion medium to prepare their dispersion, then preferably a binder precursor necessary for matrix formation (e.g., ionizing radiation-curable polyfunctional monomer or polyfunctional oligomer to be mentioned below) and a photopolymerization initiator are added thereto to prepare a coating composition for high-refractivity layer or middle-refractivity layer, and the coating composition for high-refractivity layer or middle-refractivity layer is applied onto a transparent support, on which the ionizing radiation-curable compound (e.g., polyfunctional monomer or polyfunctional oligomer) is crosslinked or polymerized to cure it, thereby forming the intended layer.

Preferably, the binder in the high-refractivity layer and the middle-refractivity layer is crosslinked or polymerized with the dispersant simultaneously with or after the layer formation.

The binder in the thus-formed high-refractivity layer and middle-refractivity layer may be, for example, such that the above-mentioned preferred dispersant and the ionizing radiation-curable polyfunctional monomer or polyfunctional oligomer are crosslinked or polymerized and the anionic group of the binder is thereby caught in the binder. Further, the anionic group in the binder in the high-refractivity layer and the middle-refractivity layer has the function of maintaining the dispersed state of the inorganic particles in the layer, and the crosslinked or polymerized structure imparts a film-forming ability to the binder thereby improving the physical strength, the chemical resistance and the weather resistance of the inorganic particles-containing high-refractivity layer and middle-refractivity layer.

The amount of the binder in the high-refractivity layer may be from 5 to 80% by mass of the solid content of the coating composition for the layer.

Preferably, the content of the inorganic particles in the high-refractivity layer is from 10 to 90% by mass of the high-refractivity layer, more preferably from 15 to 80% by mass, even more preferably from 15 to 75% by mass. Two or more different types of inorganic particles may be in the high-refractivity layer.

In case where a low-refractivity layer is formed on the high-refractivity layer, the refractive index of the high-refractivity layer is preferably higher than the refractive index of the transparent support.

A binder prepared through crosslinking or polymerization of an aromatic ring-having, ionizing radiation-curable compound, an ionizing radiation-curable compound having a halogen element except fluorine (e.g., Br, I, Cl), or an ionizing radiation-curable compound having an atom of S, N or P, may be also preferred for use in the high-refractivity layer.

The thickness of the high-refractivity layer may be suitably planned depending on the use of the film. In case where the high-refractivity layer is used as an optical interference layer to be mentioned below, its thickness is preferably from 20 to 200 nm, more preferably from 50 to 170 mm, even more preferably from 60 to 150 nm.

The haze of the high-refractivity layer is preferably lower, when the layer does not contain particles having the ability to impart a light-scattering function to the layer. Concretely, the haze is preferably at most 5%, more preferably at most 3%, even more preferably at most 1%.

Preferably, the high-refractivity layer is formed on the transparent support directly thereon or via any other layer therebetween.

(Low-Refractivity Layer)

For reducing the reflectance of the film, the film must have a low-refractivity layer.

Preferably, the refractive index of the low-refractivity layer is from 1.20 to 1.46, more preferably from 1.25 to 1.46, even more preferably from 1.30 to 1.46.

Preferably, the thickness of the low-refractivity layer is from 50 to 200 nm, more preferably from 70 to 100 nm. Preferably, the haze of the low-refractivity layer is at most 3%, more preferably at most 2%, most preferably at most 1%. Concretely, the hardness of the low-refractivity layer is preferably at least H in a pencil hardness test under a load of 500 g, more preferably at least 2 H, most preferably at least 3 H.

For enhancing the soil resistance of the optical film, the surface of the film preferably has a contact angle to water of at least 90 degrees, more preferably at least 95 degrees, even more preferably at least 100 degrees.

The curing composition preferably comprises (A) a fluoropolymer, (B) inorganic particles, and (C) an organosilane compound.

A binder may be in the low-refractivity layer for dispersing and fixing the fine particles therein. The binder may be the same as that in the above-mentioned hard coat layer, but is preferably formed of a fluoropolymer or a fluorine-containing sol-gel material to give a binder having a low refractive index by itself. The fluoropolymer or the fluorine-containing sol-gel material is preferably such that it may be crosslinked by heat or ionizing radiations, that the dynamic friction coefficient of the surface of the formed low-refractivity layer is from 0.03 to 0.30, and that the surface of the layer has a contact angle to water of from 85 to 120°.

(Antistatic Layer)

Preferably, an antistatic layer is formed on the film for preventing static charging on the film surface. Formed on the film, the antistatic layer may prevent a trouble of static charge-caused dusting in the production process where plastic supports are handled.

For forming the antistatic layer, herein employable is any known method of, for example, a method of applying a conductive coating liquid that contains conductive fine particles and a reactive curable resin, or a method of forming a thin conductive film through vapor deposition or sputtering with a thin film-forming metal or metal oxide.

The antistatic layer may be formed on a support directly thereon or via a primer layer therebetween for enhancing the adhesiveness of the layer to the support. As the case may be, the antistatic layer may act as a part of an antireflection film. In this case, when the layer is near to the outermost layer, then it may sufficiently exhibit its antistatic performance even though the film is thin.

Preferably, the thickness of the antistatic layer is from 0.01 to 10 μm, more preferably from 0.03 to 7 μm, even more preferably from 0.05 to 5 μm.

The surface resistivity of the antistatic layer is preferably from 10⁵ to 10¹² Ω/sq, more preferably from 10⁵ to 10⁹ Ω/sq, most preferably from 10⁵ to 10⁸ Ω/sq. The surface resistivity of the antistatic layer may be measured according to a four-probe process.

Preferably, the antistatic layer is substantially transparent. Concretely, the haze of the antistatic layer is preferably at most 10%, more preferably at most 5%, even more preferably at most 3%, most preferably at most 1%. The light transmittance at a wavelength of 550 nm of the layer is preferably at least 50%, more preferably at least 60%, even more preferably at least 65%, most preferably at least 70%.

The antistatic layer has high hardness. Concretely, the hardness of the antistatic layer is preferably at least H in a pencil test under a load of 1 kg, more preferably at least 2 H, even more preferably at least 3 H, most preferably at least 4 H.

The antistatic layer is, for example, a layer containing a conductive metal oxide particles, and, in general, it further contains a binder. The conductive metal oxide particles are acicular particles, preferably having a ratio of the major axis to the minor axis (major axis/minor axis) of from 3 to 50. More preferably, the particles have a ratio of major axis/minor axis of from 10 to 50. Preferably, the minor axis of the acicular particles of the type falls within a range of from 0.001 to 0.1 μm, more preferably within a range of from 0.01 to 0.02 μm. The major axis of the particles preferably falls within a range of from 0.1 to 5.0 μm, more preferably within a range of from 0.1 to 2.0 μm.

The material of the conductive metal oxide particles includes ZnO, TiO₂, SnO₂, Al₂O₃, In₂O₃, MgO, BaO and MoO₃ and their composite oxides, and those metal oxides additionally having any other hetero atom. The metal oxides are preferably SnO₂, ZnO, Al₂O₃, TiO₂, In₂O₃ and MgO, more preferably SnO₂, ZnO, In₂O₃ and TiO₂, even more preferably SnO₂. Examples of the metal oxides having a minor hetero atom include ZnO doped with from 0.01 to 30 mol % (preferably from 0.1 to 10 mol %) of a hetero element of Al or In; TiO₂ with Nb or Ta; In₂O₃ with Zn; and SnO₂ with Sb, Nb or halogen element. When the amount of the hetero element is smaller than 0.01 mol %, then the oxides or the composite oxides could not have sufficient conductivity; but when larger than 30 mol %, then the degree of blackness of the particles may increase and the antistatic layer containing the particles may blacken, and therefore the particles are unsuitable to photosensitive materials. Accordingly, the material of the conductive metal oxide particles is preferably a metal oxide or a composite metal oxide containing a minor hetero element. Also preferred is a material having an oxygen defect in its crystal structure. The conductive metal oxide particles having a minor hetero atom are preferably antimony-doped SnO₂ particles, more preferably SnO₂ particles doped with from 0.2 to 2.0 mol % of antimony. Accordingly, it is advantageous to use metal oxide particles such as antimony-doped SnO₂ particles having the above-mentioned minor axis and major axis dimension for forming a transparent and conductive antistatic layer.

When acicular metal oxide particles having the above-mentioned minor axis and major axis dimension (e.g., antimony-doped SnO₂) are sued, then a transparent and conductive antistatic layer may be advantageously used. This may be because of the following reasons: Extending long therein, the acicular metal oxide particles may be so aligned in the antistatic layer that their major axis direction may be parallel to the surface of the antistatic layer and only the length of the minor axis may occupy the thickness direction of the layer. Since the acicular metal oxide particles are long in the major axis direction as so mentioned hereinabove, they may be readily in contact with each other as compared with ordinary spherical particles, and therefore even though their amount in the layer is small, they may ensure high conductivity. Accordingly, not detracting from the transparency of the layer, the particles may act to lower the surface electric resistivity of the layer. In addition, the acicular metal oxide particles are such that the diameter of the minor axis thereof is generally smaller than or nearly the same as the thickness of the antistatic layer, and therefore they do not protrude out of the layer surface. Even though they may protrude out, the protruding part may be slight, and the antistatic layer may be completely covered with the surface layer formed thereon.

The antistatic layer generally contains a binder that acts to disperse and support the conductive metal oxide particles in the layer. The material of the binder includes various polymers such as acrylic resins, vinyl resins, polyurethane resins, polyester resins. From the viewpoint of preventing powder from dropping from the layer, the binder is preferably a cured product of a polymer (preferably acrylic resin, vinyl resin, polyurethane resin or polyester resin) and a carbodiimide compound. From the viewpoint of ensuring good working environments and of preventing air pollution, it is desirable that both the polymer and the carbodiimide compound are soluble in water, or they are used as an aqueous dispersion such as emulsion. The polymer has any group of a methylol group, a hydroxyl group, a carboxyl group and an amino group in order that it may crosslink with a carbodiimide compound. Preferred are a hydroxyl group and a carboxyl group; and more preferred is a carboxyl group. The hydroxyl group or carboxyl group content of the polymer is preferably from 0.0001 to 1 equivalent/kg, more preferably from 0.001 to 1 equivalent/kg.

The acrylic resin includes a homopolymer of any monomer of acrylic acid, acrylate such as alkyl acrylate, acrylamide, acrylonitrile, methacrylic acid, methacrylate such as alkyl methacrylate, methacrylamide and methacrylonitrile, and a copolymer obtained through polymerization of two or more such monomers. Of those, preferred are a homopolymer of any monomer of acrylate such as alkyl acrylate and methacrylate such as alkyl methacrylate, and a copolymer obtained through polymerization of two or more such monomers. For example, they include a homopolymer of any monomer of acrylate and methacrylate with an alkyl group having from 1 to 6 carbon atoms; and a copolymer obtained through polymerization of two or more such monomers. The acrylic resin is a polymer that comprises the above-mentioned composition as its essential ingredient and is obtained partly by the use of a monomer having any group of a methylol group, a hydroxyl group, a carboxyl group and an amino group so as to be crosslinkable with a carbodiimide compound.

The vinyl resin includes polyvinyl alcohol, acid-modified polyvinyl alcohol, polyvinyl formal, polyvinyl butyral, polyvinyl methyl ether, polyolefin, ethylene/butadiene copolymer, polyvinyl acetate, vinyl chloride/vinyl acetate copolymer, vinyl chloride/(meth)acrylate copolymer and ethylene/vinyl acetate copolymer (preferably ethylene/vinyl acetate/(meth)acrylate copolymer). Of those, preferred are polyvinyl alcohol, acid-modified polyvinyl alcohol, polyvinyl formal, polyolefin, ethylene/butadiene copolymer, and ethylene/vinyl acetate copolymer (preferably ethylene/vinyl acetate/acrylate copolymer). The vinyl resin of polyvinyl alcohol, acid-modified polyvinyl alcohol, polyvinyl formal, polyvinyl butyral, polyvinyl methyl ether and polyvinyl acetate may be, for example, so designed that a vinyl alcohol unit is kept remaining in the polymer so that the polymer may have a hydroxyl group and is crosslinkable with a carbodiimide compound; and the other polymer may be produced, for example, partly by the use of a monomer having any group of a methylol group, a hydroxyl group, a carboxyl group and an amino group so that the polymer is crosslinkable with the compound.

The polyurethane resin includes urethanes that are derived from at least any one of polyhydroxy compounds (e.g., ethylene glycol, propylene glycol, glycerin, trimethylolpropane), aliphatic polyester-type polyols obtained through reaction of polyhydroxy compounds and polybasic compounds, polyether polyols (e.g., poly(oxypropylene ether) polyol, poly(oxyethylene-propylene ether) polyol), polycarbonate-type polyols, and polyethylene terephthalate polyols, or their mixture and a polyisocyanate. In the polyurethane resin, for example, the hydroxyl group having remained unreacted after the reaction of polyol and polyisocyanate may be utilized as a functional group crosslinkable with a carbodiimide compound.

The polyester resin is generally a polymer obtained through reaction of a polyhydroxy compound (e.g., ethylene glycol, propylene glycol, glycerin, trimethylolpropane) and a polybasic acid. In the polyester resin, for example, the hydroxyl group and the carboxyl group having remained unreacted after the reaction of polyol and polybasic acid may be utilized as a functional group crosslinkable with a carbodiimide compound. Needless-to-say, a third component having a functional group such as a hydroxyl group may be added to it.

Of the polymers mentioned above, preferred are acrylic resin and polyurethane resin; and more preferred is acrylic resin.

The carbodiimide compound usable herein is preferably a compound having plural carbodiimide structures in the molecule.

Polycarbodiimide is produced generally through condensation of an organic diisocyanate. The organic group in the organic diisocyanate to be used for production of the compound having plural carbodiimide structures in the molecule is not specifically defined, and may be any of aromatic or aliphatic groups or their mixture. From the viewpoint of the reactivity of the compound, the group is preferably an aliphatic group.

The starting material for the compound includes organic isocyanates, organic diisocyanates and organic triisocyanates.

Examples of the organic isocyanates usable herein are aromatic isocyanates, aliphatic isocyanates and their mixtures.

Concretely, they are 4,4′-diphenylmethane diisocyanate, 4,4-diphenyldimethylmethane diisocyanate, 1,4-phenylene diisocyanate, 2,4-tolylene diisocyanate, 2,6-tolylene diisocyanate, hexamethylene diisocyanate, cyclohexane diisocyanate, xylylene diisocyanate, 2,2,4-trimethylhexamethylene diisocyanate, 4,4′-dicyclohexylmethane diisocyanate, 1,3-phenylene diisocyanate. The organic monoisocyanate usable herein includes isophorone isocyanate, phenyl isocyanate, cyclohexyl isocyanate, butyl isocyanate, naphthyl isocyanate.

The carbodiimide compound for use herein may be commercially available, for example, as Carbodilite V-02-L2 (trade name, by Nisshin Boseki).

Preferably, the amount of the carbodiimide compound to be used herein is from 1 to 200% by mass of the binder, more preferably from 5 to 100% by mass.

For forming the antistatic layer, for example, the above-mentioned conductive metal oxide particles are, directly as they are or after dispersed in a solvent such as water (optionally containing a dispersant and a binder) to prepare a dispersion, added to an aqueous solution or dispersion containing the above-mentioned binder (e.g., polymer, carbodiimide compound and suitable additive), and mixed (optionally dispersed) to prepare a coating liquid for antistatic layer formation. The antistatic layer may be formed by applying the above coating liquid for antistatic layer formation onto the surface of a plastic film such as a polyester film, according to a well-known coating method of, for example, a dip-coating method, an air knife-coating method, a curtain-coating method, a wire bar-coating method, a gravure-coating method or an extrusion-coating method. The plastic film such as polyester film to be coated may be in any stage of before successive biaxial stretching, simultaneous biaxial stretching, before re-stretching after monoaxial stretching, or after biaxial stretching. The surface of the plastic support on which the coating liquid for antistatic layer formation is applied is preferably subjected to previous surface treatment of UV treatment, corona treatment or glow discharge treatment.

The thickness of the antistatic layer is preferably within a range of from 0.01 to 1 μm, more preferably within a range of from 0.01 to 0.2 μm. When the thickness is less than 0.01 μm, then it would be difficult to uniformly apply the coating agent onto the support to form such a thin layer and the product may have coating unevenness; but when the thickness is more than 1 μm, then the antistatic performance and the scratch resistance of the layer may be poor. Preferably, the amount of the conductive metal oxide particles to be in the antistatic layer is within a range of from 10 to 1000% by mass of the binder therein (for example, the total of the above-mentioned polymer and carbodiimide compound), more preferably within a range of from 100 to 500% by mass. When the amount is less than 10% by mass, then the layer could not exhibit sufficient antistatic performance; but when more than 1000% by mss, then the haze of the layer may be too high.

The antistatic layer and the surface layer mentioned below may optionally contain additives such as a mat agent, a surfactant and a lubricant. The mat agent may be particles of an oxide such as silicon oxide, aluminium oxide or magnesium oxide having a particle size of from 0.001 to 10 μm, or particles of a polymer or copolymer such as polymethyl methacrylate or polystyrene. The surfactant may be any known anionic surfactant, cationic surfactant, ampholytic surfactant, or non-ionic surfactant. The lubricant include natural wax such as carnauba wax; phosphate of a higher alcohol having from 8 to 22 carbon atoms, or its amine salt; palmitic acid, stearic acid, behenic acid or their ester; and silicone compound.

On the antistatic layer, generally formed is a layer essentially for imparting thereto adhesiveness to an adhesive layer and for assisting the function of preventing the dropout of the conductive metal oxide particles from the antistatic layer. Various polymers may be used for the material of the layer, generally such as acrylic resin, vinyl resin, polyurethane resin, polyester resin; and preferred are the polymers mentioned hereinabove for the binder to be in the antistatic layer.

The crosslinking agent usable herein is preferably an epoxy compound. Preferred examples of the epoxy compound are 1,4-bis(2′,3′-epoxypropyloxy)butane, 1,3,5-triglycidyl isocyanurate, 1,3-diglycidyl-5-(γ-acetoxy-β-oxypropyl) isocyanurate, sorbitol polyglycidyl ethers, polyglycerol polyglycidyl ethers, pentaerythritol polyglycidyl ethers, diglycerol polyglycidyl ether, 1,3,5-triglycidyl (2-hydroxyethyl)isocyanurate, glycerol polyglycerol ethers and trimethylolpropane polyglycidyl ethers. Their commercial products are, for example, Denacol EX-521 and EX-614B (by Nagase Chemtex), to which, however, the invention should not be limited.

For forming the above layer, for example, the above polymer, epoxy compound and suitable additive are added to a solvent such as water (optionally containing a dispersant and a binder), and mixed (optionally dispersed) to prepare a coating liquid for surface layer formation.

The above layer may be formed by applying the above coating liquid for surface layer formation onto the antistatic layer of the invention, according to a well-known coating method of, for example, a dip-coating method, an air knife-coating method, a curtain-coating method, a wire bar-coating method, a gravure-coating method or an extrusion-coating method. The thickness of the surface layer is preferably within a range of from 0.01 to 1 μm, more preferably within a range of from 0.01 to 0.2 μm. When the thickness is less than 0.01 μm, then the function of the layer of preventing the dropout of the conductive metal oxide particles from the antistatic layer may be insufficient; but when more than 1 μm, then it would be difficult to uniformly apply the coating liquid and the product may have coating unevenness.

(Soil-Resistant Layer)

A soil-resistant layer may be provided as the outermost surface of the film of the invention. The soil-resistant layer lowers the surface energy of the underlying antireflection layer so that the antireflection layer may hardly have hydrophilic or hydrophobic soil adhering thereto.

The soil-resistant layer may be formed of a fluoropolymer or a soil-resistant agent.

The thickness of the soil-resistant layer is preferably from 2 to 100 nm, more preferably from 5 to 30 mm.

(Adhesion)

In the invention, in order to enhance the adhesiveness between the above light-scattering layer and the polarizing element of a polarizer, the film that comprises a polyester resin as the essential ingredient for the polarizer-protective film of the invention may be subjected to corona discharge treatment or glow discharge treatment for enhancing the adhesiveness of the film.

(Adhesive Layer)

For further enhancing the adhesiveness of the film of the invention, it is desirable to form an adhesive layer on the film.

In the invention, it is desirable to form an adhesive layer of an undercoat layer that comprises an acrylic ester-type latex, a methacrylic acid-type latex or a styrene-type latex, on a film support comprising a polyester film as the essential ingredient thereof. The latex may also be a copolymer latex obtained through emulsion polymerization of a monomer mixture comprising (a) a diolefin monomer, (b) a vinyl monomer and (c) at least one monomer having at least two of vinyl groups, acryloyl groups, methacryloyl groups and allyl groups in one molecule, in the presence of a polymerization chain transfer agent that comprises (d) an α-methylstyrene dimer and any other polymerization chain transfer agent, in an aqueous medium.

The diolefin monomer (a) that is one monomer to form the copolymer includes conjugated dienes such as butadiene, isoprene, chloroprene, and butadiene is especially preferred.

The vinyl monomer (b) that is the second component of the copolymer may be any one having a vinyl group, but is preferably the following: Styrene, acrylonitrile, methyl methacrylate, vinyl chloride, vinyl acetate and their derivatives, alkyl acrylate, acrylamide, methacrylamide, acrolein, methacrolein, glycidyl acrylate, glycidyl methacrylate, 2-hydroxyethyl acrylate, 2-hydroxyethyl methacrylate, allyl acrylate, allyl methacrylate, N-methylolated acrylamide, N-methylolated methacrylamide, vinyl isocyanate, allyl isocyanate.

The styrene derivatives include, for example, methylstyrene, dimethylstyrene, ethylstyrene, diethylstyrene, isopropylstyrene, butylstyrene, hexylstyrene, cyclohexylstyrene, decylstyrene, benzylstyrene, chloromethylstyrene, trifluoromethylstyrene, ethoxymethylstyrene, acetoxymethylstyrene, methoxystyrene, 4-methoxy-3-methylstyrene, dimethoxystyrene, chlorostyrene, dichlorostyrene, trichlorostyrene, tetrachlorostyrene, pentachlorostyrene, bromostyrene, dibromostyrene, iodostyrene, fluorostyrene, trifluorostyrene, 2-bromo-4-trifluoromethylstyrene, 4-fluoro-3-trifluoromethylstyrene, methyl vinylbenzoate.

Of acrylates, preferred are glycidyl (meth)acrylate and 2-hydroxyethyl (meth)acrylate.

The monomer (c) having at least two of vinyl groups, acryloyl group, methacryloyl groups and allyl groups in the molecule that is the third component of the copolymer may be a crosslinking agent generally used in polymerization of vinyl monomers, such as divinyl benzene, 1,5-hexadien-3-yne, hexatriene, divinyl ether, divinyl sulfone, diallyl phthalate, diallyl carbinol, diethylene glycol dimethacrylate, trimethylolpropane trimethacrylate, trimethylolpropane dimethacrylate.

Preferably, the content of the diolefin monomer (a) in the copolymer is from 10 to 60% by mass of the overall copolymer, more preferably from 15 to 40% by mass. Preferably, the content of the vinyl monomer (b) is from 40 to 90% by mass; and more preferably, the content of the above vinyl monomer of especially styrenes is from 40 to 70% by mass. The content of the monomer (c) having at least two of vinyl groups, acryloyl group, methacryloyl groups and allyl groups in the molecule is preferably from 0.01 to 10% by mass of the total of the diolefin monomer (a) and the vinyl monomer (b), more preferably from 0.1 to 5% by mass.

The α-methylstyrene dimer in the polymerization chain transfer agent (d) includes isomers of (i) 2,4-diphenyl-4-methyl-1-pentene, (ii) 2,4-diphenyl-4-methyl-2-pentene, (iii) 1,1,3-trimethyl-3-phenylindane. A preferred composition of the α-methylstyrene dimer is such that the component (i) is at least 40% by mass and the component (ii) and/or the component (iii) is at most 60% by mass; more preferably the component (i) is at least 50% by mass and the component (ii) and/or the component (iii) is at most 50% by mass; even more preferably the component (i) is at least 70% by mass and the component (ii) and/or the component (iii) is at most 30% by mass. With the increase in the proportion of the component (i), the agent may express better chain transfer performance.

Not detracting from the object of the invention, the α-methylstyrene dimer may contain impurities, for example, unreacted α-methylstyrene, and any other α-methylstyrene oligomer and α-methylstyrene polymer than the above components (i), (ii) and (iii). Not detracting from its object, the α-methylstyrene dimer may be used herein in the unpurified state thereof after its production.

The proportion of the α-methylstyrene dimer in the polymerization chain transfer agent (d) may be from 2 to 100% by mass, preferably from 3 to 100% by mass, more preferably from 5 to 95% by mass. When the proportion of the α-methylstyrene dimer is less than 2% by mass, then a copolymer latex having good adhesion strength and good blocking resistance could not be obtained. Combined with any other polymerization chain transfer agent, the reactivity of the α-methylstyrene dimer in polymerization may be increased.

The amount of the polymerization chain transfer agent (d) to be used herein may be from 0.3 to 10 parts by mass per 100 parts by mass of the monomer mixture, preferably from 0.5 to 7 parts by mass. When the amount of the polymerization chain transfer agent (d) is less than 0.3 parts by mass, then the blocking resistance of the copolymer may be poor; but when it is more than 10 parts by mass, then the adhesion strength thereof may lower unfavorably. The amount of the α-methylstyrene dimer to be used herein is preferably from 0.1 to 5 parts by mass relative to 100 parts by mass of the monomer mixture.

The other chain transfer agent that may be combined with the α-methylstyrene dimer in the polymerization chain transfer agent (d) may be any known polymerization chain transfer agent generally used in emulsion polymerization. Concretely, for example, it includes mercaptans such as octylmercaptan, n-dodecylmercaptan, t-dodecylmercaptan, n-hexadecylmercaptan, n-tetradecylmercaptan, t-tetradecylmercaptan; xanthogene disulfides such as diethylxanthogene disulfide, diisopropylxanthogene disulfide; thiuram disulfides such as tetramethylthiuram disulfide, tetraethylthiuram disulfide, tetrabutylthiuram disulfide; halogenohydrocarbons such as carbon tetrachloride, ethylene chloride; hydrocarbons such as pentaphenylethane; and acrolein, methacrolein, allyl alcohol, 2-ethylhexyl thioglycolate, terpinolene, α-terpinene, γ-terpinene, dipentene. One or more of these may be used either singly or as combined. Of those, preferred are mercaptans, xanthogene disulfides, thiuram disulfides, and carbon tetrachloride.

The copolymer latex may be produced according to an ordinary emulsion polymerization method, except for using the above-mentioned monomer mixture and polymerization chain transfer agent. Specifically, the copolymer latex may be produced by adding the monomer mixture and a polymerization initiator, an emulsifier and a polymerization chain transfer agent to an aqueous medium and polymerizing it in a mode of emulsion polymerization/

The copolymer latex may be applied onto a polyester film support to form an undercoat layer (adhesive layer) thereon. The thickness of the coating layer is preferably from 50 to 1000 nm, more preferably from 50 to 300 nm, even more preferably from 50 nm to 200 nm.

In forming the undercoat layer (adhesive layer) on a polyester film support, it is desirable to use a dichloro-s-triazine-type crosslinking agent along in the copolymer latex. Combined with a dichloro-s-triazine-type crosslinking agent, the adhesion strength of the copolymer layer may significantly increase in an ordinary-humidity condition, and even in a high-humidity condition and in a low-humidity condition, and therefore the film is hardly cracked even in a low-humidity condition, and, in addition, the antistatic property, the scratch resistance, the waterproofness and the solvent resistance of the layer may be bettered.

The dichloro-s-triazine-type crosslinking agent usable herein is represented by the following general formula (2) and/or (3):

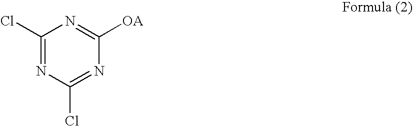

In formula (2), A represents an alkyl group, a cyclic alkyl group, an aryl group, an aralkyl group, a metal atom, or a hydrogen atom.

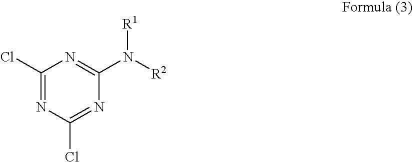

In formula (3), R¹ and R² each represent a hydrogen atom, an alkyl group, a cyclic alkyl group, an aryl group, an aralkyl group, —NHR³ (where R³ represents an alkyl group or an acyl group); and R¹ and R² may bond to each other and may form a 5- or 6-membered ring containing any of O, S and N—R⁴ (where R⁴ represents an alkyl group).

The dichloro-s-triazine-type crosslinking agent may be added in an amount of from 0.1 to 100 parts by mass of the monomer mixture. When the amount of the dichloro-s-triazine-type crosslinking added is less than 0.1 parts by mass, then the adhesion power of the layer could not increase sufficiently, and the cracking-resistant effect as well as the antistatic property, the scratch resistance, the waterproofness and the solvent resistance of the layer may be insufficient. On the other hand, when the amount of the dichloro-s-triazine-type crosslinking agent added is more than 100 parts by mass, then much unreacted crosslinking agent may remain after the reaction and may move into the overlying gelatin layer to overcure the layer whereby the adhesiveness of the layer to emulsion or the backing layer may lower unfavorably.

Examples of the dichloro-s-triazine-type crosslinking agent are mentioned below. 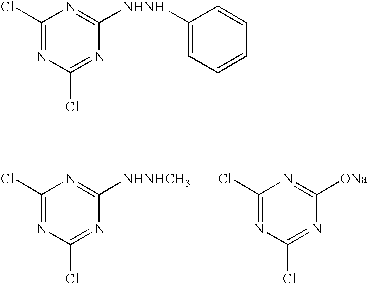
(Hydrophilic Polymer-Containing Layer)

Preferably, a second undercoat layer comprising a hydrophilic polymer as the essential binder therein is formed on the above undercoat layer (adhesive layer).

The hydrophilic polymer includes synthetic or natural hydrophilic polymer compounds, for example, gelatin; acylated gelatin such as phthalated gelatin, maleated gelatin; cellulose derivatives such as carboxymethyl cellulose, hydroxyethyl cellulose; grafted gelatins prepared by grafting gelatin with acrylic acid, methacrylic acid or amide; polyvinyl alcohol, polyhydroxyalkyl acrylate, polyvinylpyrrolidone, copoly-vinylpyrrolidone-vinyl acetate, casein, agarose, albumin, sodium alginate, polysaccharide, agar, starch, grafted starch, polyacrylamide; homopolymer or copolymer of N-substituted acrylamide and N-substituted methacrylamide, and their partial hydrolyzates. One or more of these may be used herein either singly or as combined. Gelatin and its derivatives are preferred for the hydrophilic polymer.

The undercoating liquid may be applied according to a well-known coating method of, for example, a dip-coating method, an air knife-coating method, a curtain-coating method, a roller-coating method, a wire bar-coating method, a gravure-coating method, or an extrusion-coating method using a hopper as in U.S. Pat. No. 2,681,294.

The thickness of the adhesive layer and the hydrophilic polymer-containing layer is preferably within a range of from 0.05 to 1.0 μm. When the thickness of the adhesive layer is less than 0.05 μm, then the layer could not exhibit sufficient adhesiveness; and even when it is more than 1.0 μm, its adhesiveness would be saturated.

If desired, a UV absorbent may be added to the adhesive layer and the hydrophilic polymer-containing layer.

From the viewpoint of the excellent UV-absorbing capability thereof and of the excellent liquid-crystal display performance of the device comprising the film, the UV absorbent is preferably such that the light transmittance at a wavelength of 380 nm of the whole polarizer-protective film with the UV absorbent added to the layer may be from 0 to 50%, more preferably from 0 to 30%, even more preferably from 0 to 10%, and that the light transmittance at a wavelength of 600 nm thereof may be from 80 to 100%, more preferably from 85 to 100%, even more preferably from 90 to 100%.

(Curl-Preventive Layer)

The film of the invention may be processed for curl prevention. The curl-preventing treatment is to make the film have a function of preventing it from being curled in the direction in which the processed surface thereof is inside the film. As processed for curl prevention on one surface of the transparent resin film so that the film could be surface-treated on both surfaces thereof in a different manner to a different degree, the film may be prevented from being curled in the direction in which the processed surface thereof is inside the film.

The curl-preventive layer may be formed in two embodiments: In one embodiment, the layer is formed on a side of the substrate opposite to the side thereof on which the light-scattering layer is formed; and in the other, the layer is formed on the same side of the substrate.

A concrete method of curl-preventing treatment comprises applying a solvent or forming a transparent resin layer of a solvent combined with cellulose triacetate, cellulose diacetate or cellulose acetate propionate. Concretely, the solvent application method comprises applying a composition that contains a solvent capable of dissolving or swelling the polyester film used for the polarizer-protective film. In this, however, the solvent to be used may be a mixture of a dissolving solvent and/or a swelling solvent and it may additionally contain a solvent not dissolving the film. Depending on the curling degree of the transparent resin film and on the type of the resin, such solvents may be mixed in any desired ratio to prepare a solvent composition and may be used in the method in an amount suitable for the treatment. Apart from it, transparent hard coat treatment or antistatic treatment may also exhibit the intended curl-preventing function.

(Primer Layer/Inorganic Thin Layer)

In the film of the invention, a known primer layer or inorganic thin layer may be disposed between the substrate and the laminate structure to thereby increase the gas-barrier performance of the film.

The primer layer may be formed of, for example, acrylic resin, epoxy resin, urethane resin or silicone resin. The primer layer may also be an organic/inorganic hybrid layer, in which the inorganic thin film layer is preferably an inorganic vapor-deposition layer or a dense and thin, inorganic coating film. the inorganic vapor-deposition layer is preferably a vapor deposition layer of silica, zirconia or alumina. The inorganic vapor-deposition layer may be formed through vapor evaporation or sputtering.

(Curing)

After dried to remove the solvent, the coating layer of the film of the invention may be cured by leading a web of the film through a zone in which the coating layer is cured by ionizing radiation and/or heat.

The type of the ionizing radiation is not specifically defined and may be suitably selected from UV rays, electron beams, near-UV rays, visible rays, near-IR rays, IR rays and X rays, depending on the type of the curing composition to form the coating layer. Preferred are UV rays and electron beams; and more preferred are UV rays from the viewpoint that they may be handled in a simple manner and may readily give high energy.

The light source for UV rays to photopolymerize a UV-reactive compound may be any one capable of generating UV rays. For example, it includes a low-pressure mercury lamp, a middle-pressure mercury lamp, a high-pressure mercury lamp, an ultra-high-pressure mercury lamp, a carbon arc lamp, a metal halide lamp, and a xenon lamp. Also usable are an ArF excimer laser, a KrF excimer laser, an excimer lamp and a synchrotron radiation. Of those, preferred for use herein are a ultra-high-pressure mercury lamp, a high-pressure mercury lamp, a low-pressure mercury lamp, a carbon arc lamp, a xenon arc lamp and a metal halide lamp.

Electron beams are also usable similarly. The electron beams are preferably those emitted by various types of electron beam accelerators such as a Cockcroft-Walton accelerator, a Van de Graaff accelerator, a resonance transformer, an insulated core transformer, a linear-type accelerator, a dynamitron-type accelerator or a high-frequency accelerator, and having an energy level of from 50 to 1000 keV, preferably from 100 to 300 keV.

The irradiation condition may vary with different lamps. Preferably, the irradiation dose is at least 10 mJ/cm², more preferably from 50 mJ/cm² to 10000 mJ/cm², even more preferably from 50 mJ/cm² to 2000 mJ/cm². In this case, the irradiation dose distribution in the cross direction of the web is preferably from 50 to 100% of the overall web including its both edges, more preferably from 80 to 100%.

In this invention, it is desirable that at least one layer laminated on a support is cured through irradiation with ionizing radiations in a step of irradiating the layer with ionizing radiations in an atmosphere having an oxygen concentration of at most 10% by volume in such a manner that the film is heated up to a film surface temperature of 60° C. or higher for at least 0.5 seconds from the start of the irradiation with ionizing radiations.

Simultaneously with and/or continuously to the irradiation with ionizing radiations, it is also desirable that the film is heated in an atmosphere having an oxygen concentration of at most 3% by volume.

In particular, the low-refractivity layer that is the outermost layer and is thin is preferably cured according to the above method. The curing reaction is accelerated by heat and may form a coating film having good physical strength and chemical resistance.

The time for irradiation with ionizing radiations is preferably from 0.7 seconds to 60 seconds, more preferably from 0.7 seconds to 10 seconds. When the time is shorter than 0.5 seconds, then the curing reaction could not be completed and the layer could not be sufficiently cured. However, it is not so desirable to keep the low-oxygen condition for a long period of time since the equipment for the treatment may be large-sized and the treatment may require a large amount of an inert gas.

Preferably, the oxygen concentration in the atmosphere where the ionizing radiation-curable compound is crosslinked or polymerized is preferably at most 6% by volume, more preferably 4% by volume, even more preferably 2% by volume, most preferably 1% by volume. Too much reducing the oxygen concentration in the atmosphere under the necessary level may require a large amount of an inert gas such as nitrogen, and is therefore unfavorable from the viewpoint of the production cost.

For controlling the oxygen concentration to be at most 10% by volume, preferred is a method of substituting air (nitrogen concentration, about 79% by volume; oxygen concentration, about 21% by volume) with any other gas, more preferably with nitrogen (nitrogen purging).

While cured, the film surface is preferably heated at from 60° C. to 170° C. When the film surface is heated at lower than 60° C., then the thermal curing may be ineffective; but when heated at higher than 170° C., then it is problematic in point of substrate deformation. More preferably, the heating temperature is from 60° C. to 100° C. The film surface temperature means the temperature of the film surface of the layer to be cured. The time within which the film may reach the above temperature is preferably from 0.1 seconds to 300 seconds from the start of UV irradiation, more preferably at most 10 seconds. When the time for which the film surface is kept at the temperature within the above range is too short, then the reaction of the film-forming curable composition could not be promoted; but on the contrary, when too long, it may cause other problems in that the optical properties of the film may worsen and the necessary equipment must be large-sized.

The heating method is not specifically defined. For example, preferred are a method of heating a roll and contacting it with a film; a method of applying hot nitrogen jet to a film; and a method of irradiating a film with far-IR rays or IR rays. Also employable is a method of heating a film by applying a medium flow of hot water, steam or oil to a rotary metal roll, as in Japanese Patent 2523574. A dielectric heating roll may also be used as a heating unit.

UV irradiation may be applied to every layer of the constitutive plural layers every time when each layer is formed; or may be applied to the laminated structure. As the case may be, the methods may be combined. From the viewpoint of the producibility, UV irradiation after lamination of plural layers is preferred.

In the invention, at least one layer laminated on a support may be cured through irradiation with ionizing radiations that is repeated plural times. In this case, it is desirable that the irradiation with ionizing radiations to be repeated at least two times is attained in continuous reaction chambers in which the oxygen concentration is not more than 3% by volume. Repeatedly attaining the irradiation with ionizing radiations plural times in the reaction chambers having the same low oxygen concentration will make it possible to effectively ensure the reaction time necessary for the curing.

Especially when the production line speed is increased for high producibility, repeated irradiation with ionizing radiations will be necessary for ensuring the energy of ionizing radiations necessary for the curing reaction.

When the degree of curing (100—remaining functional group content) of a layer is a certain value less than 100%, it is desirable to form another layer over the layer and to cure it through irradiation with ionizing radiations and/or heating in such a manner that the degree of curing of the lower layer could be higher than that before the upper layer is formed thereon, since the adhesiveness between the lower layer and the upper layer may be enhanced.

(Handling)

For continuously producing the film of the invention, the process comprises a step of continuously unrolling and feeding out a support film roll, a step of applying a coating liquid thereon and drying it, a step of curing the coating film, and a step of winding up the cured layer-having support film.

A film support roll is continuously unrolled and fed out into a clean room, in which the film support is discharged by an electrostatic discharger, and then the impurities adhering onto the film support are removed by a dust remover. Next, in the coating zone in the clean room, a coating liquid is applied onto the film support, and the coated film support is then conveyed to a drier room and dried therein.

The dried coating layer-having film support is then conveyed from the drier room to a curing room, in which the monomer in the coating layer is polymerized and cured. Further, the cured layer-having film support is conveyed to a curing zone, in which the layer is completely cured. The completely cured layer-having film support is then wound up as a roll.

The above steps may be batchwise carried out for the individual operations, or may be continuously carried out by providing plural sections of coating zone-drier room-curing zone in which the formation of the respective layers is carried out continuously.

In producing the film of the invention, it is desirable that the coating liquids are processed through precision filtration and, in addition, the coating step in the coating zone and the drying step in the drier room are attained in an air atmosphere having a high degree of cleanness, and further, the impurities and dust are completely removed from the surface of the film before the film is coated, as so mentioned hereinabove. The degree of atmosphere cleanness in the coating step and the drying step is preferably not below class 10 (the atmosphere contains at most 353 particles having a size of 0.5 μm or more per m³) based on the degree of atmosphere cleanness in US Standard 209E, more preferably not below class 1 (the atmosphere contains at most 35.3 particles having a size of 0.5 μm or more per m³). It is more desirable that the degree of atmosphere cleanness is also high even in the other feeding zone and winding-up zone than the coating-drying zone.

(Production of Polarizer)

When attached to at lest one surface of a polarizing element, the polarizer-protective film of the invention may construct a polarizer. Preferably to the other surface of the polarizing element, stuck is another polarizer-protective film having a moisture permeability of from 700 to 3000 g/m²·day, more preferably from 1000 to 1700 g/m²·day. TAC generally used in the art is preferred for it.

An ordinary cellulose acetate film may be used, but a cellulose acetate film produced according to a solution film formation method and stretched at a draw ratio of from 10 to 100% in the cross direction of a roll of the film may also be used.

Further, the polarizer of the invention may be such that its one surface is coated with a polarizer-protective film of the invention and the protective film on the other surface is an optical compensatory film having an optically-anisotropic layer of a liquid-crystal compound.

In addition, the polarizer of the invention may be such that its one surface is coated with a polarizer-protective film of the invention and the protective film on the other surface is a film having Re of from 0 to 10 nm and Rth of from −20 to 20 nm (e.g., see JP-A 2005-301227, paragraph [0095]).

The polarizing film includes an iodine-based polarizing film, a dichroic dye-containing polarizing film and a polyene-based polarizing film. For producing the iodine-based polarizing film and the dye-containing polarizing film, generally used is a polyvinyl alcohol film.

Of two protective films of the polarizing element, the other film than the polarizer-protective film of the invention may be an optical compensatory film that has an optically-compensatory layer containing an optically-anisotropic layer. The optical compensatory film (retardation film) may improve the viewing angle performance of a liquid-crystal display panel.

Any known optical compensatory film may be used herein. From the viewpoint of enlarging the viewing angle of displays, preferred for use herein is the optical compensatory film described in JP-A 2001-100042.

When the polarizer-protective film of the invention is used in a liquid-crystal display device, then it is preferably disposed on the viewing side of the device opposite to the liquid-crystal cell in the device.

(Liquid-Crystal Display Device)

The film and the polarizer of the invention are advantageously used in image display devices such as liquid-crystal display devices, and are preferably used as the outermost layer of such displays.

A liquid-crystal display device has two polarizers disposed on both sides of a liquid-crystal cell therein, and the liquid-crystal cell carries a liquid crystal between two electrode substrates. In this, one optically-anisotropic layer is disposed between the liquid-crystal cell and one polarizer, or two optically-anisotropic layers may be disposed between the liquid crystal cell and the two polarizers.

The liquid-crystal cell is preferably a TN-mode, VA-mode, OCB-mode, IPS-mode or ECB-mode one.

(TN Mode)

In a TN-mode liquid-crystal cell, rod-shaped liquid-crystal molecules are substantially horizontally aligned and are twisted at 60 to 120° during no voltage application thereto.

A TN-mode liquid-crystal cell is used in most color TFT liquid-crystal display devices, and is described in numerous literature.

(VA Mode)

In a VA-mode liquid-crystal cell, rod-shaped liquid-crystal molecules are substantially vertically aligned during no voltage application thereto.

A VA-mode liquid-crystal cell includes (1) a VA-mode liquid-crystal cell in the narrow sense of the word, in which rod-shaped liquid-crystal molecules are substantially vertically aligned during no voltage application thereto, but are substantially horizontally aligned during voltage application thereto (described in JP-A 2-176625), and in addition to it, (2) an MVA-mode liquid-crystal cell in which the VA mode is multi-domained for viewing angle enlargement (described in SID97, Digest of Tech. Papers (preprint), 28(1997) 845), (3) an n-ASM-mode liquid-crystal cell in which rod-shaped liquid-crystal molecules are substantially vertically aligned during no voltage application thereto and are multidomain-aligned during voltage application thereto (described in Seminar of Liquid Crystals of Japan, Papers (preprint), 58-59 (1998)), and (4) a survival-mode liquid-crystal cell (announced in LCD International 98).

(OCB Mode)

An OCB-mode liquid-crystal cell is a bent alignment-mode liquid crystal cell in which rod-shaped liquid-crystal molecules are aligned in the substantially opposite directions (symmetrically) in the upper part and the lower part, and this is disclosed in U.S. Pat. Nos. 4,583,825, 5,410,422. In this, since the rod-shaped liquid-crystal molecules are symmetrically aligned in the upper part and the lower part of the liquid-crystal cell, the bent alignment-mode liquid-crystal cell has a self-optical compensatory function. Accordingly, this liquid-crystal mode is referred to as an OCB (optically compensatory bent) liquid-crystal mode. A bend alignment-mode liquid-crystal display device has the advantage of rapid response speed.

(IPS Mode)

An IPS-mode liquid-crystal cell is a system of switching it into a nematic liquid crystal by applying a horizontal electric field thereto, and this is described in detail in Proc. IDRC (Asia Display '95), pp. 577-580 and pp. 707-710.

(ECB Mode)

In an ECB-mode liquid-crystal cell, rod-shaped liquid-crystal molecules are substantially horizontally aligned during no voltage application thereto. An ECB mode is one of liquid-crystal display modes having a most simple structure, and, for example, this is described in detail in JP-A 5-203946.

(Brightness-Increasing Film)

As a brightness-increasing film used is a polarization conversion element having the function of dividing the outgoing light from a light source (backlight) into transmitted polarized light and reflected polarized light or scattered polarized light. The brightness-increasing film of the type may increase the output efficiency of linear polarized light, taking advantage of the returning light of the reflected polarized light or the scattered polarized light from a backlight.

For example, its embodiment is an anisotropic reflecting polarizing element. The anisotropic reflecting polarizing element includes an anisotropic multi-layer thin film which transmits linear polarized light in one oscillation direction and reflects linear polarized light in the other oscillation direction. The anisotropic multi-layer thin film is, for example, 3M's DBEF (e.g., see JP-A 4-268505). The anisotropic reflecting polarizing element is, for example, a composite structure comprising a cholesteric liquid-crystal layer and a λ/4 plate. One example of the composite structure is Nitto Denko's PCF (see JP-A 11-231130). The anisotropic reflecting polarizing element also includes a reflecting grid polarizing element. Examples of the reflecting grid polarizing element are a metal grid reflecting polarizing element in which the metal grid is micropatterned and which gives reflected polarized light even in a visible light region (e.g., see U.S. Pat. No. 6,288,840), and a reflecting polarizing element produced by putting metal particles in a polymer matrix followed by stretching it (e.g., see JP-A 8-184701).

Another embodiment is an anisotropic scattering polarizing element. The anisotropic scattering polarizing element is, for example, 3M's DRP (e.g., see U.S. Pat. No. 5,825,543).

Still another embodiment is a polarizing element that enables one-pass polarization conversion. For example, smectic C* may be used therein (e.g., see JP-A 2001-201635). Also usable therein is an anisotropic diffracting grid.

In a liquid-crystal display device having a brightness-increasing film, the polarizer having the polarizer-protective film of the invention is used only on the viewing side thereof, and the film adjacent to the brightness-increasing film on the backlight side is preferably a polarizer having a film having Re and Rth of both at most 300 nm. This structure may inhibit birefringent interference and may significantly reduce rainbow-like unevenness and color change.

More preferably, a film having Re of from 0 to 10 nm and Rth of from −30 to 25 nm is used.

For example, one preferred example is TAC (by Fuji Film); and more preferred are Z-TAC (by Fuji Film), O-PET (by Kanebo) and Altesta Film (by Mitsubishi Gas Chemical).

In case where a brightness-increasing film is used, then it is desirable that the polarizer and the brightness-increasing film are kept in airtight contact with each other in order to prevent water penetration into the polarizer and to prevent light leakage from the device. The adhesive agent to be used in sticking the polarizer and the brightness-increasing film is not specifically defined. For example, it may be suitably selected from those comprising, as the base polymer thereof, any of acrylic polymers, silicone polymers, polyesters, polyurethanes, polyamides, polyvinyl ethers, vinyl acetate/vinyl chloride copolymers, modified polyolefins, epoxy polymers, fluoropolymers, rubber polymers such as natural rubber and synthetic rubber. In particular, preferably used are the adhesives having excellent optical transparency, good adhesive characteristics such as suitable wettability, aggregation performance and adhesiveness, and having excellent weather resistance and heat resistance.

(Touch Panel)

The film of the invention may be applied to touch panels such as those described in JP-A 5-127822, 2002-48913.

(Organic EL Device)

The film of the invention may be used as a substrate (substrate film) and a protective film in organic EL devices.

In case where the film of the invention is in an organic EL device, applicable thereto are the descriptions in JP-A 11-335661, 11-335368, 2001-192651, 2001-192652, 2001-192653, 2001-335776, 2001-247859, 2001-181616, 2001-181617, 2002-181816, 2002-181617, 2002-056976. Preferably, the descriptions in JP-A 2001-148291, 2001-221916, 201-231443 are referred to, as combined with the above.

(Method for Determination)

Methods for measuring various data given in this description are mentioned below.

(Moisture Permeability)

To the method of determination of moisture permeability, applicable is the description in Physical Properties of Polymer II (Polymer Experiment Lecture 4, Kyoritsu Publishing), pp. 285-294, Method for Determination of Water Vapor Permeation (mass method, thermometer method, water vapor pressure method, adsorption method). Concretely, a 70-mmφ film sample of the invention is moisture-conditioned at 60° C. and 95% RH for 24 hours, and then its moisture content per a unit area (g/m²) is computed according to JIS Z-0208 as in the following formula: Moisture permeability=(mass after moisture conditioning)−(mass before moisture conditioning).

(Tg)

Tg is determined from the peak temperature at tanδ obtained in dynamic viscoelasticity measurement. AS the device for dynamic viscoelasticity measurement, used is DVA-225 (by IT Gauge Control), and tanδ is measured at frequency of 1 Hz.

(Modulus of Elasticity)

Using a universal tensile tester, Toyo Baldwin's STM T50BP, a film sample is tested for 0.5% elongation in an atmosphere at 25° C. and 60% at a pulling speed of 10%/min whereupon its stress is measured, from which the modulus of elasticity of the sample is determined.

(Water Content)

A film sample (7 mm×35 mm) is left in a room conditioned at 25° C. and 60% RH for at least 4 hours, and then its water content is measured according to a Karl Fisher process using a water gauge and a sample drying device (CA-03, VA-05, both by Mitsubishi Chemical). The water amount (g) is divided by the sample mass (g).

(Retardation)

In this description, Re(λ) and Rth(λ) each indicate an in-plane retardation and a thickness-direction retardation, respectively, at a wavelength λ. Re(λ) is measured by applying light having a wavelength of λ nm to a film in the normal direction thereof, using KOBRA 21ADH or WR (by Oji Scientific Instruments). Unless otherwise specifically indicated, λ=590 nm in this description.

When the film to be analyzed is one represented by a monoaxial or biaxial index ellipsoid, then its Rth(λ) may be calculated according to the following method.

Re(λ) is first determined as follows: The in-plane slow axis (judged by KOBRA 21ADH or WR) is taken as an inclination axis (rotation axis) of the film (in case where the film does not have a slow axis, then any in-plane direction of the film may be the rotation axis thereof). Light having a wavelength of λ nm is applied to the film in different inclination directions relative to the normal direction of the film, at intervals of 10 degrees up to 50 degrees on one side from the normal direction, and 6 points in all are analyzed. Based on the thus-measured retardation data, the estimated mean refractive index and the inputted thickness of the film, Rth(λ) is computed by KOBRA 21ADH or WR.

In the above, in case where the film has a direction at a certain inclination angle from the normal direction around the in-plane slow axis as the rotation axis, in which its retardation is zero, then the retardation value of the film is changed to a negative one at an inclination angle larger than that inclination angle, and then Rth(λ) is computed by KOBRA 21ADH or WR.

Rth may also be calculated as follows: The slow axis of the film to be analyzed is taken as an inclination angle (rotation angle) thereof (in case where the film does not have a slow axis, then any in-plane direction of the film may be the rotation axis thereof). The retardation of the film is measured in any inclined two directions. Based on the data and the estimated mean refractive index and the inputted thickness of the film, Rth may be calculated according to the following formulae (1) and (2):

$$\begin{matrix}Formula ( 1 ) \text{:} & \\ Re ( θ ) = [ nx - \frac{ny \times nz}{\sqrt{\begin{matrix}{( ny sin ( {sin}^{- 1} ( \frac{sin ( - θ )}{nx} ) ) )}^{2} + \\ {( nz cos ( {sin}^{- 1} ( \frac{sin ( - θ )}{nx} ) ) )}^{2}\end{matrix}}} ] \times \frac{d}{cos ( {sin}^{- 1} ( \frac{sin ( - θ )}{nx} ) )} & \end{matrix}$$

In the above, Re(θ) indicates the retardation in the direction inclined by an angle θ from the normal direction of the film.

In formula (1), nx indicates the in-plane refractive index of the film in the slow axis direction; ny indicates the in-plane refractive index of the film in the direction perpendicular to nx; nz indicates the refractive index of the film in the direction perpendicular to nx and ny.
Rth=((nx+ny)/2−nz)×d Formula (2):

In case where the film to be analyzed could not be expressed as a monoaxial or biaxial index ellipsoid, or that is, when the film does not have an optical axis, then its Rth(λ) may be calculated as follows:

Re(λ) is first determined. The in-plane slow axis (judged by KOBRA 21ADH or WR) is taken as an inclination axis (rotation axis) of the film. Light having a wavelength of λ nm is applied to the film in different inclination directions relative to the normal direction of the film, at intervals of 10 degrees between −50 degrees and 50 degrees from the normal direction, and 11 points in all are analyzed. Based on the thus-measured retardation data, the estimated mean refractive index and the inputted thickness of the film, Rth(λ) is computed by KOBRA 21ADH or WR.

In the above-mentioned measurement, the data given in Polymer Handbook (John Wiley & Sons, Inc.) and catalogues of various optical films may be referred to for the estimated mean refractive index of the film. When the mean refractive index is unknown, it may be measured with an Abbe's refractiometer. Values of mean refractive index of some typical optical films are as follows: Cellulose acylate (1.48), cyclo-olefin polymer (1.52), polycarbonate (1.59), polymethyl methacrylate (1.49), polystyrene (1.59). When the estimated value of mean refractive index and the thickness of the film are inputted therein, then KOBRA 21ADH or WR computes nx, ny and nz. The thus-computed data nx, ny and nz give Nz=(nx−nz)/(nx−ny).

(Surface Roughness)

The center line mean height (Ra) may be determined according to JIS-B0601.

(Haze)

The haze of the film of the invention is a haze value defined in JIS-K7105, and it is automatically measured, using a haze meter, Nippon Denshoku's NDH-1001DP according to the measurement method defined in JIS-K7361-1, as in the following formula: Haze=(diffused light/total transmitted light)×100 (%).

(Hardness)

(Pencil Hardness)

The hardness of the film of the invention may be determined in a pencil hardness test according to JIS-K5400.

Preferably, the pencil hardness of the film is at least H, more preferably at least 2H, most preferably at least 3 H.

The surface hardness of the film may also be determined through nanoindentation as in JP-A 2004-354828. In this case, the hardness of the film is preferably from 2 GPa to 4 GPa, and the nanoindentation tensile modulus thereof is preferably from 10 GPa to 30 GPa.

(Evaluation of Adhesiveness)

The interlayer adhesiveness and the adhesiveness between the support and the coating layer of the film of the invention may be evaluated according to the following method.

Using a cutter knife, 100 square cross cuts of 11 vertical lines and 11 horizontal lines at intervals of 1 mm are made on the surface of a film sample having a coating layer formed thereon. An adhesive polyester tape (Nitto Denko's No. 31B) is stuck to it, left for 24 hours and peeled away. This is repeated three times at the same place, and the cross cuts are visually checked for their peeling.

Samples on which at most 10 of 100 cross cuts are peeled off are good; and those on which at most 2 cross cuts are peeled off are better.

(Spectral Characteristics)

A sample (13 mm×40 mm) is analyzed with a spectrophotometer (Hitachi's U-3210) at 25° C. and 60% RH, and its light transmittance at a wavelength of from 300 to 450 nm is measured.

The value b of the sample is measured with a color-difference meter, Nippon Denshoku's SZ-Σ90 Model.

### EXAMPLES

The invention is described more concretely with reference to the following Examples, to which, however, the embodiments of the invention should not be limited.

(Production of Starting Resin)

A polyester A was produced according to an ordinary method for production of polyethylene terephthalate.

A polyester S having a sulfonic acid group was produced according to the following method.

(Production of Sulfonic Acid Group-Having Polyethylene Terephthalate)

0.1 parts by mass of calcium acetate hydrate was added to 100 parts by mass of dimethyl terephthalate and 64 parts by mass of ethylene glycol for ordinary interesterification.

To the resulting product, added were 35 parts by mass of an ethylene glycol solution of 5-sodiumsulfo-di(β-hydroxyethyl) isophthalate (concentration, 31% by mass) (6.3 mol %/total dicarboxylic acid component), 5.8 parts by mass of polyethylene glycol (number-average molecular weight, 3000) (5% by mass/produced polyester), 0.05 parts by mass of antimony trioxide and 0.13 parts by mass of trimethyl phosphate.

Next, this was gradually heated with reducing the pressure, and polymerized at 280° C. and 40 Pa to obtain a polyester S.

### Example 1

(Production of Polarizer-Protective Film)

(Production of Polyester Film)

Using a Henschel mixer in a paddle drier, chips of the polyester A were dried to have a water content of at most 50 ppm, and then melted in an extruder in which the heater temperature was set at 280° C. to 300° C. The melted polyester resin was jetted out through a die part onto an electrostatically-charged chiller roll to obtain an amorphous base. The amorphous base was stretched at a draw ratio of 3.3 times in the base-running direction, and then stretched at a draw ratio of 3.9 times in the cross direction of the base, thereby producing a polyester film PET having a thickness of 100 μm for a polarizer-protective film 1.

In the same manner but using the polyester S, a polyester film PETS having a thickness of 80 μm was produced.

(Undercoat Layer S1 (Adhesive Layer))

One surface of the polyester film PET for polarizer-protective film 1 (this is to be a boundary interface to a light-scattering layer to be formed thereon) was subjected to corona discharge treatment just before coated, and the following coating liquid was applied onto it so that the dry thickness of the coating layer could be 90 nm, thereby forming ah adhesive layer (S1) thereon.

| | | |
|---|---|---|
| Styrene-butadiene latex (solid content, 43%) | 300 | g |
| 2,4-Dichloro-6-hydroxy-2-triazine sodium salt (8%) | 49 | g |
| Distilled water | 1600 | g |

(Formation of Light-Scattering Layer)
(Preparation of Sol a-2)

In a 1,000-ml reactor equipped with an thermometer, a nitrogen-introducing duct and a dropping funnel, fed were 187 g (0.80 mol) of acryloxypropyltrimethoxysilane, 27.2 g (0.20 mol) of methyltrimethoxysilane, 320 g (10 mol) of methanol and 0.06 g (0.001 mol) of KF, and with stirring at room temperature, 15.1 g (0.86 mol) of water was gradually dropwise added thereto. After the addition, this was stirred at room temperature for 3 hours, and then heated and stirred under reflux of methanol for 2 hours. Next, the low-boiling component was evaporated away under reduced pressure, and the residue was filtered to obtain 120 g of a sol, a-2. Thus obtained, the substance was analyzed through GPC, and its mass-average molecular weight was 1500. Of the oligomer and higher polymer components of the substance, those having a molecular weight of from 1000 to 20000 was 30%.

¹H-NMR confirmed that the substance obtained herein has a structure of the following formula:

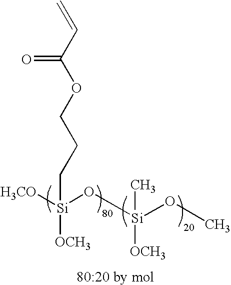

²⁹Si—NMR confirmed that the degree of condensation, α, of the product is 0.56. These data in analysis show that the most part of the silane coupling agent sol is a linear structure part.

Gas chromatography of the substance confirmed that the starting acryloxypropyltrimethoxysilane remained in the product in a proportion of at most 5%.

(1) Preparation of Coating Liquid for Light-Scattering Layer:

Composition of Coating Liquid A-1 for Light-Scattering Layer
(antiglare hard coat layer)

| | | |
|---|---|---|
| PET-30 | 50.0 | g |
| Irgacure 184 | 2.0 | g |
| SX-350 (30%) | 1.5 | g |
| Crosslinked acryl-styrene particles (30%) | 13.0 | g |
| FP-1 | 0.75 | g |
| Sol a-2 | 9.5 | g |
| Toluene | 38.5 | g |

Composition of Coating Liquid A-2 for Light-Scattering Layer
(antiglare hard coat layer)

| | | |
|---|---|---|
| PET-30 | 46.0 | g |
| Irgacure 184 | 1.7 | g |
| MX-600 (30%) | 28.6 | g |
| FP-1 | 0.06 | g |
| Sol a-2 | 6.0 | g |
| MiBK (methyl isobutyl ketone) | 14.0 | g |
| MEK (methyl ethyl ketone) | 5.0 | g |

Composition of Coating Liquid A-3 for Light-Scattering Layer
(antiglare hard coat layer)

| | | |
|---|---|---|
| PET-30 | 50.0 | g |
| Irgacure 184 | 2.0 | g |
| SX-300 (30%) | 1.7 | g |
| Crosslinked acryl-styrene particles (30%) | 13.3 | g |
| FP-1 | 0.06 | g |
| Sol a-2 | 10.0 | g |
| Toluene | 38.5 | g |

Composition of Coating Liquid A-4 for Light-Scattering Layer
(antiglare hard coat layer)

| | | |
|---|---|---|
| PET-30 | 40.0 | g |
| DPHA | 6.0 | g |
| Irgacure 184 | 2.0 | g |
| MX-800 (30%) | 28.6 | g |
| FP-1 | 0.06 | g |
| Sol a-2 | 6.0 | g |
| MiBK | 14.0 | g |
| MEK | 5.0 | g |

The coating liquids were filtered through a polypropylene filter having a pore size of 30 μm to prepare coating liquids A-1 to A-4 for light-scattering layer.

The materials used in the above are mentioned below.

PET-30: mixture of pentaerythritol triacrylate and pentaerythritol tetraacrylate [by Nippon Kayaku].

Irgacure 184: polymerization initiator [by Ciba Speciality Chemicals].

SX-350: crosslinked polystyrene particles having a mean particle size of 3.5 μm [having a refractive index of 1.60, by Soken Chemical; 30% toluene dispersion, used after dispersed for 20 minutes at 10000 rpm in a polytron disperser].

Crosslinked acryl-styrene particles: having a mean particle size of 3.5 μm [having a refractive index of 1.55, by Soken Chemical; 30% toluene dispersion, used after dispersed for 20 minutes at 10000 rpm in a polytron disperser].

FP-1: fluorine-containing surface improver.

MX-600: PMMA particles having a mean particle size of 6 μm [having a refractive index of 1.49, by Soken Chemical; 30% MiBK dispersion, used after dispersed for 20 minutes at 10000 rpm in a polytron disperser].

MX-800: PMMA particles having a mean particle size of 8 μm [having a refractive index of 1.49, by Soken Chemical; 30% MiBK dispersion, used after dispersed for 20 minutes at 10000 rpm in a polytron disperser].

(2) Formation of Light-Scattering Layer (Antiglare Hard Coat Layer):

A roll of the polyester film PET for polarizer-protective film 1, coated with the undercoat layer S1, was unrolled, and the coating liquid A-1 for light-scattering layer (antiglare hard coat layer) was directly applied onto the S1-coated surface of the film, using a microgravure roll having a diameter of 50 mm and having a gravure pattern of 135 lines/inch having a depth of 60 μm, and a doctor blade, at a film-traveling speed of 10 m/min, then dried at 60° C. for 150 seconds, and thereafter irradiated with UV rays at an illuminance of 400 mW/cm2 and at a dose of 250 mJ/cm2, using an air-cooled metal halide lamp (by Eye Graphics) under nitrogen purging, thereby curing the coating layer. Then, the film was wound up.

(Undercoating for Polarizing Element)

An undercoat layer of the following formulation was formed on the surface of the film, on which the film is stuck to a polarizing element.

(Undercoat Layer SS1 (Adhesive Layer))

The surface of the polyester film PET for polarizer-protective film 1, opposite to the surface thereof coated with the undercoat layer S1 and the light-scattering layer formed thereon, was subjected to corona discharge treatment, and then the following coating liquid was applied thereonto so as to form a coating layer having a dry thickness of 90 nm, thereby forming an adhesive layer (SS1).

| | | |
|---|---|---|
| Styrene-butadiene latex (solid content, 43%) | 300 | g |
| 2,4-Dichloro-6-hydroxy-2-triazine sodium salt (8%) | 49 | g |
| Distilled water | 1600 | g |

(Hydrophilic Polymer Layer SS2)

Next, after formed and dried, the coating layer SS1 was subjected to corona discharge treatment and then a coating liquid for hydrophilic polymer layer mentioned below was applied thereonto so as to form a coating layer having a dry thickness of 100 nm, thereby forming a hydrophilic polymer layer (SS2) thereon. Thus, a polarizer-protective film 1 was obtained.

| | | |
|---|---|---|
| Gelatin | 30 | g |
| Acetic acid (20%) | 20 | g |
| Distilled water | 1900 | g |

(Production of Polarizing Element)

A polyvinyl alcohol film having a thickness of 120 μm was dipped in an aqueous solution containing 1 part by mass of iodine, 2 parts by mass of potassium iodide and 4 parts by mass of boric acid, and then stretched by 4 times at 50° C. to produce a polarizing element.

(Other Polarizer-Protective Film)

A WV film coated with an optically-anisotropic layer (by Fuji Film) was dipped in an aqueous sodium hydroxide solution (1.5 mol/L) at 55° C., then washed with water and dried.

(Production of Polarizer)

The above polarizing element was stuck to the SS2-coated surface of the polarizer-protective film 1 and to the surface of the above saponified WV film opposite to the surface thereof coated with the optically-anisotropic layer, using an adhesive of an aqueous 5% solution of completely-saponified polyvinyl alcohol, thereby producing a polarizer 1.

(Performance of Liquid-Crystal Display Device)

The polarizer in a liquid-crystal display device comprising a TN-mode liquid-crystal cell (Mitsubishi Electric's MRT-191S) was peeled off, and in place of it, the polarizer 1 of the invention was stuck to the device with an adhesive in such a manner that its polyester resin film surface could face outside (on the air interface side) and that the transmission axis of the polarizer could be the same as that of the polarizer originally stuck to the device. In a dark room, the liquid-crystal display device was driven, and its performance was evaluated in point of the following characteristics thereof, by visually observing its panel at various viewing angles. The results are shown in Table 4.

(Evaluation of Image in point of Rainbow-Like Unevenness)

The liquid-crystal display device was visually evaluated by plural panelists in point of the presence or absence of rainbow-like unevenness in display, and of the presence or absence of viewing angle-dependent contrast change or color change.
Good: Rainbow-like unevenness and viewing angle-dependent contrast change and color change were seen little.
Bad: Rainbow-like unevenness and viewing angle-dependent contrast change and color change were seen definitely.
   (Evaluation of Light-Leakage after High-Humidity and Low-Humidity Treatment (Evaluation of Peripheral Unevenness))

The liquid-crystal display device was processed at 60° C. and 90% RH for 50 hours and at 70° C. and 10% RH for 50 hours, and then it was left in an atmosphere at 25° C. and 60% RH for 2 hours. Then, the liquid-crystal display device was driven to a black level, whereupon the light leakage at the front of the device was visually evaluated by plural panelists.

Excellent: No light leakage was seen.

Good: Little light leakage was seen.

Bad: Light leakage was seen definitely.

### Examples 2 to 28, Comparative Examples 1 to 3

(Production of Polarizer-Protective Film)

(Polarizer-Protective Films 2 to 17, T)

In place of the polarizer-protective film 1 in Example 1, a polarizer-protective film 2 was produced in which the amount of the coating liquid for the hard coat layer was 1/2; a polarizer-protective film 3 was produced in which the scattering particles (SX-350, crosslinked acryl-styrene particles) were not in the coating liquid for the hard coat layer; a polarizer-protective film 4 was produced in which the starting polyester for the polyester film was changed to the polyester S; a polarizer-protective film 5 was produced in which the starting polyester was changed to the polyester S and the light-scattering layer was not formed; and a polarizer-protective film 7 was produced in which the thickness of the polyester film was changed. In addition, polarizer-protective films 6, and 8 to 14 were produced in which polyester films PET-UV1 to PET-UV8 (Table 1) that had been prepared by kneading a UV absorbent with the starting polyester were used.

In addition, in Example 1, polarizer-protective films 15 to 17 were produced in which the polyester film was changed to PET-UV1 and the coating liquids for the light-scattering layer (hard coat layer) were changed from A-1 to A-2, A-3 or A-4.

The UV absorbent-containing polyester films PET-UV1 to PET-UV8 were prepared as follows:

A UV absorbent as in Table 1 (of the following compounds of formula (2), (3), (4)) was kneaded with the starting polyester A or S and formed into chips, and the chips were blended with polyester A or S chips. The amount of the UV absorbent added to the polyester was so controlled that the content thereof in the resulting polyester mixture could be as in Table 1 below in terms of % of the overall polyester resin in the mixture. Using a Henschel mixer in a paddle drier, the resin chips were dried to have a water content of at most 50 ppm, and then melted in an extruder in which the heater temperature was set at 280° C. to 300° C. The melted polyester resin was jetted out through a die part onto an electrostatically-charged chiller roll to obtain an amorphous base. The amorphous base was stretched at a draw ratio of 3.3 times in the base-running direction, and then stretched at a draw ratio of 3.9 times in the cross direction of the base, thereby producing polyester films PET-UV1 to PET-UV8 having a thickness as in Table 2 (100 μm, 80 μm). No UV absorbent bled out on the obtained polyester films. Regarding the UV absorbent bleeding resistance thereof, the film sheets were left in an atmosphere at 60° C. and 90% RH for 10 days, and then visually checked for the presence or absence of bleeding out of the UV absorbent on their surfaces.

TABLE 1

| | | | | | Light Transmittance (%) | |
|---|---|---|---|---|---|---|
| Film | UV Absorbent | Starting Material | Amount Added (%) | Mass Loss (%) | 380 nm | 600 nm |
| PET-UV1 | compound (1) | polyester A | 0.4 | 0.1 | 40 | 86 |
| PET-UV2 | compound (2) | polyester A | 0.8 | 1 | 3 | 83 |
| PET-UV3 | compound (3) | polyester A | 0.6 | 0.2 | 30 | 84 |
| PET-UV4 | mixture of compounds (2)/(3) (1/1) | polyester A | 0.5 | 0.6 | 40 | 85 |
| PET-UV5 | compound (1) | polyester S | 0.4 | 0.1 | 40 | 86 |
| PET-UV6 | compound (2) | polyester S | 0.8 | 1 | 3 | 83 |
| PET-UV7 | compound (3) | polyester S | 0.6 | 0.2 | 30 | 84 |
| PET-UV8 | mixture of compounds (2)/(3) (1/1) | polyester S | 0.5 | 0.6 | 40 | 85 |

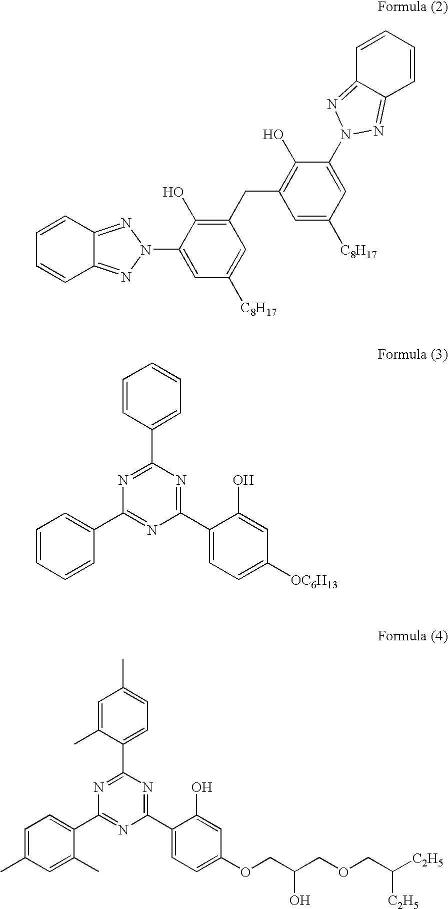 (Polarizer-Protective Film 18)

In the process of producing the polarizer-protective film 8, an undercoat layer mentioned below (on the light-scattering layer side and on the polarizing element side) was formed.

(Undercoat Layer S2)

Two layers were formed on one surface (this is to be the lamination interface adjacent to the light-scattering layer) of the PET-UV2 film, according to the method mentioned below.

Conveyed at a speed of 105 m/min, the support surface was subjected corona discharge treatment at 727 J/m², and then a coating liquid for antistatic layer having the composition mentioned below was applied onto it according to a bar-coating method.

The coating amount was 7.1 cc/m², and this was dried in an in-air-floating drying zone at 180° C. for 1 minute, thereby forming an antistatic layer.

(Coating Liquid for First Layer (antistatic layer))

| Distilled water | 781.7 parts by weight |
|---|---|
| Polyacryl resin (Julimer ET-410 by Nippon | 30.9 parts by weight |
| Jun-yaku; solid content, 30%) | |
| Acicular tin oxide particles (FS-10D by | 131.1 parts by weight |
| Ishihara Sangyo; solid content, 20%) | |
| Carbodiimide compound (Carbodilite V-02-L2 | 6.4 parts by weight |
| by Nisshinbo; solid content, 40%) | |
| Surfactant (Sanded BL by Sanyo Chemical | 1.4 parts by weight |
| Industry; solid content, 44.6%) | |
| Surfactant (Nanoacty HN-100 by Sanyo | 0.7 parts by weight |
| Chemical Industry; solid content 100%) | |
| Silica particles dispersion (Seahoster KE-W30 | 5.0 parts by weight |
| by Nippon Shokubai; 0.3 μm; solid content, | |
| 20%) | |

Kept conveyed at a speed of 105 m/min, a coating liquid for surface layer having the composition mentioned below was applied onto the film according to a bar-coating method, after the formation of the antistatic layer thereon.

The coating amount was 5.05 cc/m², and this was dried in an in-air-floating drying zone at 160° C. for 1 minute, thereby forming a 2-layered back layer.

(Coating Liquid for Second Layer (surface layer))

| | |
|---|---|
| Distilled water | 941.0 parts by weight |
| Polyacryl resin (Julimer ET-410 by Nippon | 57.3 parts by weight |
| Jun-yaku; solid content, 30%) | |
| Epoxy compound (Denacol EX-521 by Nagase | 1.2 parts by weight |
| Chemical Industry; solid content, 100%) | |
| Surfactant (Sanded BL by Sanyo Chemical | 0.5 parts by weight |
| Industry; solid content, 44.6%) | |

(Undercoating on the Side of Polarizing Element)

Two layers were formed on the other surface (this is to be the lamination interface adjacent to the polarizing element) of the PET-UV2 film, according to the method mentioned below.

Conveyed at a speed of 105 m/min, the opposite surface of the support was subjected corona discharge treatment at 467 J/m², and then a coating liquid for first undercoat layer having the composition mentioned below was applied onto it according to a bar-coating method.

The coating amount was 5.05 cc/m², and this was dried in the same in-air-floating drying zone as the drying zone for the back antistatic layer, at 180° C. for 1 minute, thereby forming a first undercoat layer.

(First Undercoat Layer)

| | |
|---|---|
| Distilled water | 823.0 parts by weight |
| Styrene-butadiene copolymer latex (Nipol Latex | 151.5 parts by weight |
| LX407C5 by Nippon Zeon; solid content, 40%) | |
| 2,4-Dichloro-6-hydroxy-s-triazine sodium salt | 25.0 parts by weight |
| (H-232 by Sankyo Chemical; solid content, 8%) | |
| Polystyrene fine particles (mean particle size 2μ) | 0.5 parts by weight |
| (Nipol UFN1008 by Nippon Zeon; solid | |
| content, 10%) | |

Kept conveyed at a speed of 105 m/min, a coating liquid for surface layer having the composition mentioned below was applied onto the film according to a bar-coating method, after the formation of the first undercoat layer thereon.

The coating amount was 8.7 cc/m², and this was dried in an in-air-floating drying zone at 160° C. for 1 minute, thereby forming a 2-layered back layer.

| (Second Undercoat Layer) | | |
|---|---|---|
| Distilled water | 982.4 | parts by weight |
| Gelatin (alkali-processed) | 14.8 | parts by weight |
| Methyl cellulose (TC-5 by Shin-etsu Chemical | 0.46 | parts by weight |
| Industry) | | |
| Compound (Cpd-21) | 0.33 | parts by weight |
| Proxel (Cpd-22; solid content, 3.5%) | 2.0 | parts by weight |

Compound (Cpd-21)

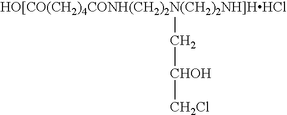

Compound (Cpd-22)

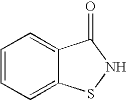

(Film 19)

In the process of producing the polarizer-protective film 1, a film PET2 was formed by changing the stretching condition as in Table 2.

However, since the resulting film could not have a sufficient film strength and its surface profile was not good, and the film could not be worked into a polarizer.

TABLE 2

| | | | | Draw Ratio in Stretching | | |
|---|---|---|---|---|---|---|
| | | | | running direction/cross | Moisture | Retardation Re |
| | Film | Starting Material | Thickness | direction | Permeability | (nm) |
| Polarizer-Protective Film 1 | PET | Polyester A | 100 | 3.3/3.9 | 90 | 1700 |
| Polarizer-Protective Film 2 | PET | Polyester A | 100 | 3.3/3.9 | 90 | 1700 |
| Polarizer-Protective Film 3 | PET | Polyester A | 100 | 3.3/3.9 | 90 | 1700 |
| Polarizer-Protective Film 4 | PETS | Polyester S | 80 | 3.3/3.9 | 200 | 1000 |
| Polarizer-Protective Film 5 | PETS | Polyester S | 80 | 3.3/3.9 | 200 | 1000 |
| Polarizer-Protective Film 6 | PET-UV1 | Polyester A | 100 | 3.3/3.9 | 90 | 1700 |
| Polarizer-Protective Film 7 | thin PET | Polyester A | 40 | 3.3/3.9 | 230 | 900 |
| Polarizer-Protective Film 8 | PET-UV2 | Polyester A | 100 | 3.3/3.9 | 90 | 1700 |
| Polarizer-Protective Film 9 | PET-UV3 | Polyester A | 100 | 3.3/3.9 | 90 | 1700 |
| Polarizer-Protective Film 10 | PET-UV4 | Polyester A | 100 | 3.3/3.9 | 90 | 1700 |
| Polarizer-Protective Film 11 | PET-UV5 | Polyester S | 80 | 3.3/3.9 | 200 | 1000 |
| Polarizer-Protective Film 12 | PET-UV6 | Polyester S | 80 | 3.3/3.9 | 200 | 1000 |
| Polarizer-Protective Film 13 | PET-UV7 | Polyester S | 80 | 3.3/3.9 | 200 | 1000 |
| Polarizer-Protective Film 14 | PET-UV8 | Polyester S | 80 | 3.3/3.9 | 200 | 1000 |
| Polarizer-Protective Film 15 | PET-UV1 | Polyester A | 100 | 3.3/3.9 | 90 | 1700 |
| Polarizer-Protective Film 16 | PET-UV1 | Polyester A | 100 | 3.3/3.9 | 90 | 1700 |
| Polarizer-Protective Film 17 | PET-UV1 | Polyester A | 100 | 3.3/3.9 | 90 | 1700 |
| Polarizer-Protective Film 18 | PET-UV2 | Polyester A | 100 | 3.3/3.9 | 90 | 1700 |
| Film 19 | PET2 | Polyester A | 120 | 1.05/1.5 | 20 | 200 |
| Polarizer-Protective Film T | TD80 | TAC | 80 | — | 1300 | 2 |

| | | Modulus of Elasticity | | | | |
|---|---|---|---|---|---|---|
| | Tg (° C.) | (GPa) | Total Haze | Surface Haze | Internal Haze | Light Fastness |
| Polarizer-Protective Film 1 | 115 | 5 | 56 | 14 | 42 | good |
| Polarizer-Protective Film 2 | 115 | 5 | 31.5 | 30.0 | 1.5 | good |
| Polarizer-Protective Film 3 | 115 | 5 | 0.9 | 0.5 | 0.4 | good |
| Polarizer-Protective Film 4 | 100 | 4 | 62 | 20.0 | 42.0 | good |
| Polarizer-Protective Film 5 | 100 | 4 | 0.9 | 0.5 | 0.4 | good |
| Polarizer-Protective Film 6 | 113 | 5 | 50 | 30.0 | 20.0 | excellent |
| Polarizer-Protective Film 7 | 115 | 5 | 53 | 23.0 | 30.0 | good |
| Polarizer-Protective Film 8 | 113 | 5 | 55 | 35.0 | 20.0 | excellent |
| Polarizer-Protective Film 9 | 113 | 5 | 54 | 36.0 | 18.0 | excellent |
| Polarizer-Protective Film 10 | 110 | 5 | 59 | 39.0 | 20.0 | excellent |
| Polarizer-Protective Film 11 | 113 | 5 | 55 | 20.0 | 35.0 | excellent |
| Polarizer-Protective Film 12 | 113 | 5 | 67 | 25.0 | 42.0 | excellent |
| Polarizer-Protective Film 13 | 113 | 5 | 70 | 32.0 | 38.0 | excellent |
| Polarizer-Protective Film 14 | 110 | 5 | 67 | 31.0 | 36.0 | excellent |
| Polarizer-Protective Film 15 | 113 | 5 | 25.5 | 0.5 | 25.0 | excellent |
| Polarizer-Protective Film 16 | 113 | 5 | 45 | 9.0 | 36.0 | excellent |
| Polarizer-Protective Film 17 | 113 | 5 | 56 | 1.0 | 55.0 | excellent |
| Polarizer-Protective Film 18 | 113 | 5 | 55 | 35.0 | 20.0 | excellent |
| Film 19 | 115 | 5 | 70 | 20 | 50 | — |
| Polarizer-Protective Film T | 160 | 4 | 0.3 | 0.0 | 0.3 | excellent |

The polarizer-protective films 1, 2, 4 and 6 to 18 are the polarizer-protective films of the invention. On the other hand, the polarizer-protective films 3 and 5 are comparative polarizer-protective films not having a light-scattering layer. The film 19 is a comparative film not serving as a polarizer-protective film. In Table 2, given is another comparative polarizer-protective film T, TAC having a large moisture permeability (TD80 by Fuji Film).

Table 2 shows the designation of the film, the starting material, the thickness, the draw ratio in stretching (running direction/cross direction), the moisture permeability, the retardation Re, Tg, and the modulus of elasticity of the substrate films, and also shows the total haze, the surface haze and the internal haze of the films 1 to 18, T, and 19.

In addition, the polarizers were tested for lightfastness by exposing then to an Xe lamp for 24 hours. The samples with no transmittance change are “excellent”; those with some but negligible transmittance change are “good”; and those with transmittance change are “bad”.

(Production of Polarizer)

(Polarizers 2 to 18, Polarizer T)

Like the polarizer 1, polarizers 2 to 18 were produced using the polarizer-protective films 2 to 18 in place of the polarizer-protective film 1.

For comparison, a polarizer T was produced using an ordinary polarizer-protective film T, TAC (TD80 by Fuji Film) in place of the polarizer-protective film 1.

(Polarizer WV)

In the same manner as that for the polarizer 1, a polarizer WV was produced using an ordinary film TAC (TD80 by Fuji Film) in place of the WV film in the polarizer 1.

(Polarizer Z)

In the same manner as that for the polarizer 1, a polarizer Z was produced using a low-retardation film TAC (Z-TAC by Fuji Film; Re=1 nm, Rth=−3 nm) in place of the WV film in the polarizer 1.

(Polarizer WVZ)

In the same manner as that for the polarizer WV, a polarizer WVZ was produced, in which, however, the substrate film opposite to TAC of the polarizer WV was a low-retardation film TAC (Z-TAC by Fuji Film).

(Polarizer ZZ)

In the same manner as that for the polarizer Z, a polarizer ZZ was produced, in which, however, the substrate film opposite to Z-TAC of the polarizer Z was a low-retardation film TAC (Z-TAC by Fuji Film).

The polarizers 1, 2, 4, 6 to 18, WV and Z are the polarizers of the invention. On the other hand, the polarizers 3 and 5 not having a light-scattering layer, and the polarizers T, WVZ and ZZ in which a TAC film alone was used as the substrate film are comparative polarizers. (The constitution of each polarizer is given in Table 3.)

TABLE 3

| Designation of | Outer Polarizer-Protective | Inner (cell-side) |
|---|---|---|
| Polarizer | Film | Polarizer-Protective Film |
| Polarizer 1 | Polarizer-Protective Film 1 | WV Film |
| Polarizer 2 | Polarizer-Protective Film 2 | WV Film |
| Polarizer 3 | Polarizer-Protective Film 3 | WV Film |
| Polarizer 4 | Polarizer-Protective Film 4 | WV Film |
| Polarizer 5 | Polarizer-Protective Film 5 | WV Film |
| Polarizer 6 | Polarizer-Protective Film 6 | WV Film |
| Polarizer 7 | Polarizer-Protective Film 7 | WV Film |
| Polarizer 8 | Polarizer-Protective Film 8 | WV Film |
| Polarizer 9 | Polarizer-Protective Film 9 | WV Film |
| Polarizer 10 | Polarizer-Protective Film 10 | WV Film |
| Polarizer 11 | Polarizer-Protective Film 11 | WV Film |
| Polarizer 12 | Polarizer-Protective Film 12 | WV Film |
| Polarizer 13 | Polarizer-Protective Film 13 | WV Film |
| Polarizer 14 | Polarizer-Protective Film 14 | WV Film |
| Polarizer 15 | Polarizer-Protective Film 15 | WV Film |
| Polarizer 16 | Polarizer-Protective Film 16 | WV Film |
| Polarizer 17 | Polarizer-Protective Film 17 | WV Film |
| Polarizer 18 | Polarizer-Protective Film 18 | WV Film |
| Polarizer T | Polarizer-Protective Film T | WV Film |
| Polarizer WV | Polarizer-Protective Film 1 | TD80 |
| Polarizer Z | Polarizer-Protective Film 1 | Z-TAC |
| Polarizer WVZ | Z-TAC | TD80 |
| Polarizer ZZ | Z-TAC | Z-TAC |

(Performance of Liquid-Crystal Display Device)

In the same manner as in Example 1, liquid-crystal display devices were constructed in which, however, any of the polarizer T, the polarizer 2 and the polarizers 3, 4, 5, 6, 7 and 8 to 18 was used in place of the polarizer 1, and these were tested for the rainbow-like unevenness, and the light leakage at high humidity and low humidity (Comparative Example 1, Example 2, Comparative Example 2, Example 3, Comparative Example 3, Example 4, Example 5, and Examples 13 to 23—see Table 4).

In a VA-mode liquid-crystal display device (LC-26GD3 by Sharp), the polarizer was peeled off with its retardation film kept remaining as such in the device, and in place of it, the polarizer WV of the invention was stuck to the device in such a manner that its polyester resin film surface could face outside (on the air interface side) and that the transmission axis of the polarizer could be the same as that of the polarizer originally stuck to the device (Example 6).

In an IPS-mode liquid-crystal display device (Th-26LX300 by Matsushita), the polarizer was peeled off, and in place of it, the polarizer Z of the invention was stuck to the device in such a manner that its polyester resin film surface could face outside (on the air interface side) and that the transmission axis of the polarizer could be the same as that of the polarizer originally stuck to the device (Example 7).

In an IPS-mode liquid-crystal display device (32LC100 by Toshiba), the backside retardation film of the polarizer was peeled off with its front-side retardation film kept remaining as such in the device, and in place of it, the polarizer Z of the invention was stuck to the device in such a manner that its polyester resin film surface could face outside (on the air interface side) and that the transmission axis of the polarizer could be the same as that of the polarizer originally stuck to the device (Example 8).

These were tested for rainbow-like unevenness, and light leakage at high humidity and low humidity (Examples 6 to 8, see Table 4).

In the devices of Example 1, Examples 6 to 8 and 23, only the polarizer on the backlight side was changed to the polarizer T and a brightness-increasing film (DBEF by 3M) was inserted on the backlight side. These devices were tested for rainbow-like unevenness, and light leakage at high humidity and low humidity (Examples 9 to 12, 24, see Table 4).

In the device provided with the brightness-increasing film DBEF, the polarizer-protective film adjacent to the brightness-increasing film was changed to an extremely low-retardation film Z-TAC. It is known that the viewing angle-dependent color change is small in the thus-modified device (Examples 25 to 28, see Table 4).

It is known that, when the film in Examples 25 and 26 was prepared by airtightly sticking the brightness-increasing film DBEF to the polarizer with an adhesive, then it is effective for preventing the peripheral unevenness (Examples 27 and 29, see Table 4).

TABLE 4

| | | | | | | | Peripheral Unevenness | |
|---|---|---|---|---|---|---|---|---|
| | Liquid-Crystal | Combination in Polarizer | | | airtight adhesion | Rainbow-like | 60° C., 90%, | 70° C., 0%, |
| | Cell | Viewing Side | Backlight Side | DBEF | of DBEF | Unevenness | 50 hours | 50 hours |
| Example 1 | MRT-191S | Polarizer 1 | Polarizer 1 | no | no | good | excellent | excellent |
| Comparative | MRT-191S | Polarizer T | Polarizer T | no | no | good | bad | bad |
| Example 1 | | | | | | | | |
| Example 2 | MRT-191S | Polarizer 2 | Polarizer 2 | no | no | good | excellent | excellent |
| Comparative | MRT-191S | Polarizer 3 | Polarizer 3 | no | no | bad | excellent | excellent |
| Example 2 | | | | | | | | |
| Example 3 | MRT-191S | Polarizer 4 | Polarizer 4 | no | no | good | excellent | excellent |
| Comparative | MRT-191S | Polarizer 5 | Polarizer 5 | no | no | bad | excellent | excellent |
| Example 3 | | | | | | | | |
| Example 4 | MRT-191S | Polarizer 6 | Polarizer 6 | no | no | good | excellent | excellent |
| Example 5 | MRT-191S | Polarizer 7 | Polarizer 7 | no | no | good | excellent | excellent |
| Example 6 | LC-26GD3 | Polarizer WV | Polarizer WV | no | no | good | excellent | excellent |
| Example 7 | TH-26LX300 | Polarizer Z | Polarizer Z | no | no | good | excellent | excellent |
| Example 8 | 32LC100 | Polarizer Z | Polarizer Z | no | no | good | excellent | excellent |
| Example 9 | MRT-191S | Polarizer 1 | Polarizer T | yes | no | good | good | good |
| Example 10 | LC-26GD3 | Polarizer WV | Polarizer T | yes | no | good | good | good |
| Example 11 | TH-26LX300 | Polarizer Z | Polarizer T | yes | no | good | good | good |
| Example 12 | 32LC100 | Polarizer Z | Polarizer T | yes | no | good | good | good |
| Example 13 | MRT-191S | Polarizer 8 | Polarizer 8 | no | no | good | excellent | excellent |
| Example 14 | MRT-191S | Polarizer 9 | Polarizer 9 | no | no | good | excellent | excellent |
| Example 15 | MRT-191S | Polarizer 10 | Polarizer 10 | no | no | good | excellent | excellent |
| Example 16 | MRT-191S | Polarizer 11 | Polarizer 11 | no | no | good | excellent | excellent |
| Example 17 | MRT-191S | Polarizer 12 | Polarizer 12 | no | no | good | excellent | excellent |
| Example 18 | MRT-191S | Polarizer 13 | Polarizer 13 | no | no | good | excellent | excellent |
| Example 19 | MRT-191S | Polarizer 14 | Polarizer 14 | no | no | good | excellent | excellent |
| Example 20 | MRT-191S | Polarizer 15 | Polarizer 15 | no | no | good | excellent | excellent |
| Example 21 | MRT-191S | Polarizer 16 | Polarizer 16 | no | no | good | excellent | excellent |
| Example 22 | MRT-191S | Polarizer 17 | Polarizer 17 | no | no | good | excellent | excellent |
| Example 23 | MRT-191S | Polarizer 18 | Polarizer 18 | no | no | good | excellent | excellent |
| Example 24 | MRT-191S | Polarizer 18 | Polarizer T | yes | no | good | good | good |
| Example 25 | MRT-191S | Polarizer 18 | Polarizer WVZ | yes | no | good | good | good |
| Example 26 | TH-26LX300 | Polarizer Z | Polarizer ZZ | yes | no | good | good | good |
| Example 27 | MRT-191S | Polarizer 18 | Polarizer WVZ | yes | yes | good | excellent | excellent |
| Example 28 | TH-26LX300 | Polarizer Z | Polarizer ZZ | yes | yes | good | excellent | excellent |

In Examples where the polarizers 1, 2, 4, 6 to 18, WV and Z, comprising the polarizer-protective film of the invention, 1, 2, 4, 6 to 18, WV and Z, no light leakage was found at high humidity and low humidity, and no rainbow-like unevenness was also found.

In Comparative Example 1 in which the polarizer T comprising the polarizer-protective film T having a large moisture permeability, or that is, ordinary TAC (TD80) was mounted on both the viewing side and the backlight side of the device, the device produced light leakage at high humidity and low humidity.

In Comparative Examples 2 and 3, in which the polarizer 3 or 5 comprising the polarizer-protective film 3 where the hard coat layer-forming coating liquid did not contain scattering particles, or the polarizer-protective film 5 not coated with a light-scattering layer was mounted on the device, the devices produced rainbow-like unevenness and viewing angle-dependent color change.

Regarding the liquid-crystal display devices comprising the brightness-increasing film DBEF, even when a polarizer comprising the polarizer-protective film of the invention was used only as the polarizer on the viewing side and when the polarizer T, WVZ or ZZ comprising an ordinary film TAC (TD80) or Z-TAC was used on the backlight side (Examples 9 to 12, 24, 25 to 28), the devices could sufficiently prevent rainbow-like unevenness and viewing angle-dependent color change.

The present application claims foreign priority based on Japanese Patent Application (JP 2006-019376) filed Jan. 27 of 2006, Japanese Patent Application (JP 2006-143124) filed May 23 of 2006, Japanese Patent Application (JP 2006-286545) filed Sep. 8 of 2006, the contents of which is incorporated herein by reference.

1. A polarizer-protective film comprising:
a film including a polyester resin as the essential ingredient thereof, and having a moisture permeability of at most 700 g/m²·day and an in-plane retardation Re of at least 500 nm; and
a light-scattering layer provided on at least one surface of the film.

2. The polarizer-protective film as claimed in claim 1, which has a total haze of from 10 to 80%.

3. The polarizer-protective film as claimed in claim 1, which has a surface haze of from 0.3 to 70%.

4. The polarizer-protective film as claimed in claim 1, which has an internal haze of from 10 to 80%.

5. The polarizer-protective film as claimed in claim 1, wherein the film has a transmittance at 380 nm of from 0 to 50%, and has a transmittance at 600 nm of from 80 to 100%.

6. The polarizer-protective film as claimed in claim 1, wherein the film contains a UV absorbent.

7. The polarizer-protective film as claimed in claim 6, wherein, when it is heated up to a temperature of 300° C. at a heating speed of 10° C./min in nitrogen gas, the UV absorbent has mass loss of 10% or less.

8. The polarizer-protective film as claimed in claim 6, wherein the UV absorbent is at least one UV absorbent represented by formula (1): 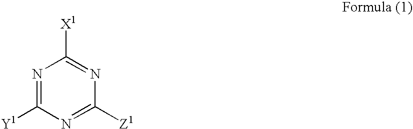
wherein X¹, Y¹ and Z¹ each independently represent a substituted or unsubstituted alkyl, aryl, alkoxy, aryloxy, alkylthio, arylthio or heterocyclic group; and at least one of X¹, Y¹ and Z¹ is a substituent represented by formula (A): 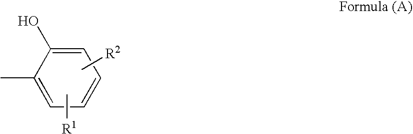
wherein R¹ and R² each independently represent a hydrogen atom, a halogen atom, a substituted or unsubstituted alkyl, alkenyl, aryl, alkoxy, aryloxy, acyloxy, alkylthio, arylthio, amino, acyl, oxycarbonyl, carbamoyl or sulfamoyl group, or a carboxyl group or a salt thereof, or a sulfo group or a salt thereof; and the adjacent R¹ and R² may bond to each other to form a ring.

9. The polarizer-protective film as claimed in claim 1, wherein the water content of the film is at most 1%.

10. The polarizer-protective film as claimed in claim 1, wherein the modulus of elasticity of the film is from 3 to 7 GPa.

11. The polarizer-protective film as claimed in claim 1, wherein the thickness of the film is from 5 to 200 μm.

12. The polarizer-protective film as claimed in claim 1, wherein the glass transition temperature of the polyester resin is 80° C. or higher.

13. The polarizer-protective film as claimed in claim 1, wherein the polyester resin has a group selected from the group consisting of a sulfonic acid and a salt thereof.

14. The polarizer-protective film as claimed in claim 1, wherein at least one surface of the film is subjected to corona discharge treatment.

15. The polarizer-protective film as claimed in claim 1, wherein at least one surface of the film is subjected to glow discharge treatment.

16. The polarizer-protective film as claimed in claim 1, wherein an adhesive layer is provided on at least one surface of the film.

17. The polarizer-protective film as claimed in claim 16, wherein the adhesive layer contains at least one selected from the group consisting of an acrylate-based latex, a methacrylic acid-based latex and a styrene-based latex.

18. The polarizer-protective film as claimed in claim 16, wherein the adhesive layer contains a UV absorbent.

19. The polarizer-protective film as claimed in claim 16, wherein the adhesive layer contains a conductive metal oxide.

20. The polarizer-protective film as claimed in claim 16, wherein the adhesive layer has a thickness of from 50 to 1000 nm.

21. The polarizer-protective film as claimed in claim 16, wherein a hydrophilic polymer-containing layer is further provided on the adhesive layer.

22. The polarizer-protective film as claimed in claim 21, wherein the hydrophilic polymer-containing layer contains a UV absorbent.

23. The polarizer-protective film as claimed in claim 21, wherein the hydrophilic polymer-containing layer has a thickness of from 50 to 1000 nm.

24. The polarizer-protective film as claimed in claim 1, wherein, in the production of the film, the film is stretched by from 1.5 times to 7 times in the film-traveling direction and by from 1.5 times to 7 times in the direction vertical to the traveling direction.

25. A polarizer comprising:
a polarizing element; and
a polarizer-protective film as claimed in claim 1 which is arranged at one side of the polarizing element.

26. The polarizer as claimed in claim 25, wherein the polarizer-protective film comprises a cellulose ester film as the essential ingredient thereof.

27. The polarizer as claimed in claim 25, wherein the polarizer-protective film has a viewing angle compensatory function.

28. The polarizer as claimed in claim 25, wherein the polarizer-protective film is coated with an optically-anisotropic layer.

29. A liquid-crystal display device comprising:
polarizers as claimed in claim 25 which are arranged at positions facing each other; and
a liquid-crystal cell interposed between the polarizers.

30. The liquid-crystal display device as claimed in claim 29, wherein the polarizer is disposed only on the viewing side of the liquid-crystal cell.

31. The liquid-crystal display device as claimed in claim 29, further comprising a brightness-improving film mounted thereon.

32. The liquid-crystal display device as claimed in claim 31, wherein the brightness-improving film and the polarizer-protective film adjacent thereto are airtightly adhered to each other.

33. The liquid-crystal display device as claimed in claim 29, which adapts a Twisted Nematic mode as a display mode.
